(19) United States
(12) Patent Application Publication
(10) Pub. No.: US 2026/0301654 A1
(43) Pub. Date: Oct. 1, 2026

(54) DISPLAY APPARATUS INCLUDING A GAMMA VOLTAGE CONTROL CIRCUIT AND ELECTRONIC APPARATUS INCLUDING THE SAME

(71) Applicant: Samsung Display Co., Ltd., Yongin-si (KR)

(72) Inventors: Hyunchang KIM, Yongin-si (KR); Se-Byung CHAE, Yongin-si (KR); Subin KIM, Yongin-si (KR)

(73) Assignee: Samsung Display Co., Ltd., Yongin-si (KR)

(21) Appl. No.: 19/440,883

(22) Filed: Jan. 6, 2026

(30) Foreign Application Priority Data
Mar. 28, 2025 (KR) 10-2025-0040252

(51) Int. Cl. G09G 3/32

(52) U.S. Cl. CPC G09G 3/32; G09G 2300/043; G09G 2300/0819; G09G 2300/0842; G09G 2310/0267; G09G 2310/027; G09G 2310/0291; G09G 2310/08; G09G 2320/0204; G09G 2320/0209; G09G 2320/0233; G09G 2320/0242; G09G 2320/0247; G09G 2320/0673; G09G 2330/028

(57) ABSTRACT

A display apparatus includes a display panel including at least one pixel, a reference voltage generator outputting a pixel reference voltage to the display panel, a gate driver outputting a gate signal to the display panel, a data driver outputting a data voltage to the display panel, a gamma voltage generating circuit outputting a gamma voltage to the data driver, and a gamma voltage control circuit outputting a first reference voltage and a second reference voltage to the gamma voltage generating circuit. The gamma voltage control circuit includes a first amplifier configured to generate the first reference voltage based on a first primitive reference voltage, the pixel reference voltage received from the display panel, and an internal reference voltage, and a second amplifier configured to generate the second reference voltage based on a second primitive reference voltage, the pixel reference voltage, and the internal reference voltage.

### CROSS-REFERENCE TO RELATED APPLICATION

This U.S. non-provisional application claims priority under 35 U.S.C. § 119 to Korean Patent Application No. 10-2025-0040252, filed on Mar. 28, 2025, in the Korean Intellectual Property Office (KIPO), the entire contents of which are herein incorporated by reference.

### BACKGROUND

Some example embodiments of the present inventive concepts relate to a display apparatus including a gamma voltage control circuit and an electronic apparatus including the display apparatus.

A display apparatus includes a display panel and a display panel driver. The display panel displays an image based on an input image and includes a plurality of gate lines, a plurality of data lines, and a plurality of pixels.

The display panel driver includes a gate driver and a data driver. The gate driver outputs gate signals to the gate lines. The data driver outputs data voltages to the data lines. The display panel driver may further include a gamma voltage generating circuit applying a gamma voltage to the data driver and a gamma voltage control circuit applying a first reference voltage and a second reference voltage for generating the gamma voltage to the gamma voltage generating circuit.

When a coupling occurs between a line applying a pixel reference voltage to the display panel and the data line, a level of the pixel reference voltage may fluctuate. When the level of the pixel reference voltage fluctuates, a level of a driving current of a light emitting element may be changed so that a luminance of the light emitting element may be changed.

In addition, when the level of the pixel reference voltage is changed according to a change of a driving condition such as a luminance, a frequency, a temperature, an image pattern and on the like, the driving current of the light emitting element may be changed so that the luminance of the light emitting element may be changed.

### SUMMARY

Some example embodiments of the present inventive concepts provide a display apparatus in which a change of a pixel reference voltage provided to a display panel is reflected in a first reference voltage and a second reference voltage applied to a gamma voltage generating circuit to improve a display quality.

Some example embodiments of the present inventive concepts provide an electronic apparatus including the display apparatus.

In some example embodiments of the present inventive concepts, a display apparatus includes a display panel, a reference voltage generator, a gate driver, a data driver, a gamma voltage generating circuit, and a gamma voltage control circuit. The display panel includes at least one pixel. The reference voltage generator is configured to output a pixel reference voltage to the display panel. The gate driver is configured to output a gate signal to the display panel. The data driver is configured to output a data voltage to the display panel. The gamma voltage generating circuit is configured to output a gamma voltage to the data driver. The gamma voltage control circuit is configured to output a first reference voltage and a second reference voltage to the gamma voltage generating circuit. The gamma voltage control circuit includes a first amplifier configured to generate the first reference voltage based on a first primitive reference voltage, the pixel reference voltage received from the display panel, and an internal reference voltage, and a second amplifier configured to generate the second reference voltage based on a second primitive reference voltage, the pixel reference voltage, and the internal reference voltage.

In some example embodiments, the first amplifier may include a non-inverting input terminal configured to receive the first primitive reference voltage and the pixel reference voltage, an inverting input terminal configured to receive the internal reference voltage, and an output terminal configured to output the first reference voltage.

In some example embodiments, the first amplifier may further include a first resistor including a first end configured to receive the first primitive reference voltage and a second end connected to the non-inverting input terminal of the first amplifier, a second resistor including a first end configured to receive the pixel reference voltage and a second end connected to the non-inverting input terminal of the first amplifier, a third resistor including a first end configured to receive the internal reference voltage and a second end connected to the inverting input terminal of the first amplifier, and a fourth including a first end connected to the inverting input terminal of the first amplifier and a second end connected to the output terminal of the first amplifier.

In some example embodiments, the gamma voltage control circuit is configured to generate the first reference voltage such that a relationship VAREG=VREG+VR−VNR is satisfied. The VAREG represents the first reference voltage, VREG represents the first primitive reference voltage, VR represents the pixel reference voltage, and VNR represents the internal reference voltage.

In some example embodiments, the second amplifier may include a non-inverting input terminal configured to receive the second primitive reference voltage and the pixel reference voltage, an inverting input terminal configured to receive the internal reference voltage, and an output terminal configured to output the second reference voltage.

In some example embodiments, the gamma voltage control circuit is configured to generate the second reference voltage such that a relationship VAREF=VREF+VR−VNR is satisfied. VREF represents the second primitive reference voltage, VR represents the pixel reference voltage, and VNR represents the internal reference voltage.

In some example embodiments, the gamma voltage control circuit may include a third amplifier configured to generate the first primitive reference voltage, a resistor string including a first end configured to receive an analog reference voltage, and a first decoder connected between the resistor string and the third amplifier.

In some example embodiments, the third amplifier may include a non-inverting input terminal connected to the first decoder, an inverting input terminal, an output terminal configured to output the first primitive reference voltage, a first resistor connected between the output terminal and the inverting input terminal, and a second resistor connected between the inverting input terminal and a ground.

In some example embodiments, the gamma voltage control circuit may further include a fourth amplifier configured to generate the second primitive reference voltage, and a second decoder connected between the resistor string and the fourth amplifier. The fourth amplifier may include a non-inverting input terminal connected to the second decoder, an inverting input terminal, an output terminal configured to output the second primitive reference voltage, a first resistor connected between the output terminal and the inverting input terminal, and a second resistor connected between the inverting input terminal and a ground.

In some example embodiments, the gamma voltage control circuit may further include a fourth amplifier configured to generate the internal reference voltage, and a third decoder connected between the resistor string and the fourth amplifier. The fourth amplifier may include a non-inverting input terminal connected to the third decoder, an inverting input terminal, an output terminal configured to output the internal reference voltage, a first resistor connected between the output terminal and the inverting input terminal, and a second resistor connected between the inverting input terminal and a ground.

In some example embodiments, the at least one pixel may include a light emitting element, and the light emitting element may be configured to output a driving current that may be proportional to a square of a difference between the data voltage and the pixel reference voltage.

In some example embodiments, the at least one pixel may include a light emitting element, a first switching element including a control electrode connected to a first node, a first electrode connected to a second node, and a second electrode connected to a third node, a second switching element including a control electrode configured to receive a writing gate signal, a first electrode configured to receive the data voltage, and a second electrode connected to the first node, a third switching element including a control electrode configured to receive a reference gate signal, a first electrode configured to receive the pixel reference voltage, and a second electrode connected to the first node, a fourth switching element including a control electrode configured to receive a light emitting element initialization gate signal, a first electrode configured to receive a light emitting element initialization voltage, and a second electrode connected to an anode electrode of the light emitting element, a fifth switching element including a control electrode configured to receive a first emission signal, a first electrode configured to receive a first power voltage, and a second electrode connected to the second node, and a sixth switching element including a control electrode configured to receive a second emission signal, a first electrode connected to the third node, and a second electrode connected to the anode electrode of the light emitting element.

In some example embodiments, the first emission signal may have an inactive level in a first period of a driving timing of the pixel. The second emission signal may have an active level in the first period. The reference gate signal may have an active level in the first period. The writing gate signal may have an inactive level in the first period. The first emission signal may have an active level in a second period subsequent to the first period. The second emission signal may have an inactive level in the second period. The reference gate signal may have the active level in the second period. The writing gate signal may have the inactive level in the second period. The first emission signal may have the inactive level in a third period subsequent to the second period. The second emission signal may have the inactive level in the third period. The reference gate signal may have an inactive level in the third period. The writing gate signal may have an active level in the third period. The light emitting element initialization gate signal may have an active level in the third period. The first emission signal may have the active level in a fourth period subsequent to the third period. The second emission signal may have the active level in the fourth period. The reference gate signal may have the inactive level in the fourth period. The writing gate signal may have the inactive level in the fourth period. The light emitting element initialization gate signal may have an inactive level in the fourth period.

In some example embodiments, the at least one pixel may include a light emitting element, a first switching element including a control electrode connected to a first node, a first electrode configured to receive a first power voltage, and a second electrode connected to a second node, a second switching element including a control electrode configured to receive a writing gate signal, a first electrode configured to receive the data voltage, and a second electrode connected to a third node, a third switching element including a control electrode configured to receive a compensation gate signal, a first electrode connected to the first node, and a second electrode connected to the second node, a fourth switching element including a control electrode configured to receive an initialization gate signal, a first electrode configured to receive an initialization voltage and a second electrode connected to the first node, a fifth switching element including a control electrode configured to receive the compensation gate signal, a first electrode configured to receive the pixel reference voltage, and a second electrode connected to the third node, a sixth switching element including a control electrode configured to receive an emission signal, a first electrode connected to the second node, and a second electrode connected to an anode electrode of the light emitting element, and a seventh switching element including a control electrode configured to receive a light emitting element initialization gate signal, a first electrode configured to receive a light emitting element initialization voltage, and a second electrode connected to the anode electrode of the light emitting element.

In some example embodiments, the at least one pixel may include a light emitting element, a first switching element including a control electrode connected to a first node, a first electrode connected to a second node, and a second electrode connected to a third node, a second switching element including a control electrode configured to receive a writing gate signal, a first electrode configured to receive the data voltage, and a second electrode connected to a fourth node, a third switching element including a control electrode configured to receive a compensation gate signal, a first electrode connected to the first node, and a second electrode connected to the third node, a fourth switching element including a control electrode configured to receive an initialization gate signal, a first electrode configured to receive an initialization voltage, and a second electrode connected to the first node, a fifth switching element including a control electrode configured to receive the compensation gate signal, a first electrode configured to receive the pixel reference voltage, and a second electrode connected to the fourth node, a sixth switching element including a control electrode configured to receive a first emission signal, a first electrode configured to receive a first power voltage, and a second electrode connected to the second node, a seventh switching element including a control electrode configured to receive a second emission signal, a first electrode connected to the third node, and a second electrode connected to an anode electrode of the light emitting element, an eighth switching element including a control electrode configured to receive a light emitting element initialization gate signal, a first electrode configured to receive a light emitting element initialization voltage, and a second electrode connected to the anode electrode of the light emitting element, and a ninth switching element including a control electrode configured to receive the light emitting element initialization gate signal, a first electrode configured to receive a bias voltage, and a second electrode connected to the second node.

In some example embodiments of the present inventive concepts, a display apparatus includes a display panel, a reference voltage generator, a data driver, a gamma voltage generating circuit and a gamma voltage control circuit. The display panel includes a pixel. The reference voltage generator is configured to output a pixel reference voltage to the display panel. The data driver is configured to output a data voltage to the display panel. The gamma voltage generating circuit is configured to output a gamma voltage to the data driver. The gamma voltage control circuit is configured to output a first reference voltage and a second reference voltage to the gamma voltage generating circuit. The at least one pixel includes a light emitting element, a driving switching element configured to apply a driving current to the light emitting element, a data writing switching element configured to apply the data voltage to a data writing node and a reference switching element configured to apply the pixel reference voltage to the data writing node. The pixel reference voltage is provided from the display panel to the gamma voltage control circuit.

In some example embodiments, the data writing node may be directly connected to a control electrode of the driving switching element.

In some example embodiments, the at least one pixel may further include a hold capacitor including a first electrode connected to the data writing node and a second electrode connected to a control electrode of the driving switching element.

In some example embodiments, the gamma voltage control circuit may include a first amplifier configured to generate the first reference voltage based on a first primitive reference voltage, the pixel reference voltage, and an internal reference voltage, and a second amplifier configured to generate the second reference voltage based on a second primitive reference voltage, the pixel reference voltage, and the internal reference voltage.

In some example embodiments of the present inventive concepts, an electronic apparatus includes a display panel, a reference voltage generator, a data driver, a gamma voltage generating circuit, a gamma voltage control circuit, a driving controller, a processor, a power voltage generator, and a power supply. The display panel includes at least one pixel. The reference voltage generator is configured to output a pixel reference voltage to the display panel. The data driver is configured to output a data voltage to the display panel. The gamma voltage generating circuit is configured to output a gamma voltage to the data driver. The gamma voltage control circuit is configured to output a first reference voltage and a second reference voltage to the gamma voltage generating circuit. The driving controller is configured to control the data driver. The processor is configured to output input image data and an input control signal to the driving controller. The power voltage generator is configured to generate an analog power voltage based on a battery voltage and output the analog power voltage to the gamma voltage control circuit. The power supply is configured to output the battery voltage to the power voltage generator. The at least one pixel includes a light emitting element, a driving switching element configured to apply a driving current to the light emitting element, a data writing switching element configured to apply the data voltage to a data writing node and a reference switching element configured to apply the pixel reference voltage to the data writing node. The gamma voltage control circuit is configured to generate an analog reference voltage based on the analog power voltage and to generate a first primitive reference voltage, a second primitive reference voltage and an internal reference voltage based on the analog reference voltage. The gamma voltage control circuit is configured to generate the first reference voltage and the second reference voltage based on the pixel reference voltage provided from the display panel, the first primitive reference voltage, the second primitive reference voltage, and the internal reference voltage.

According to the display apparatus and the electronic apparatus including the display apparatus, the gamma voltage control circuit may generate the first reference voltage and the second reference voltage using the pixel reference voltage fed back from the display panel.

Thus, a change of the pixel reference voltage may be reflected in the first reference voltage and the second reference voltage, the change of the pixel reference voltage may be reflected in the gamma voltage generated by the first reference voltage and the second reference voltage, and the change in the pixel reference voltage may be reflected in the data voltage generated by the gamma voltage.

Since the change in the pixel reference voltage is reflected in the data voltage, crosstalk in the display panel may be reduced or limited in a pixel structure in which the luminance of the light emitting element of the pixel is determined based on a driving current proportional to a square of a difference between the data voltage and the pixel reference voltage.

In addition, when the level of the pixel reference voltage is changed according to a change of a driving condition such as a luminance, a frequency, a temperature, an image pattern and the like, the change of the pixel reference voltage may be reflected in the data voltage so that optical characteristics of the display panel such as a luminance uniformity, a color uniformity, a flicker and the like may be improved.

### BRIEF DESCRIPTION OF THE DRAWINGS

The above and other features and advantages of the some example embodiments of the present inventive concepts will become more apparent by describing in example embodiments thereof with reference to the accompanying drawings.

FIG. 1 is a block diagram illustrating a display apparatus according to some example embodiments of the present inventive concepts.

FIG. 2A is a circuit diagram illustrating a gamma voltage control circuit of FIG. 1.

FIG. 2B is a circuit diagram illustrating a gamma voltage generating circuit of FIG. 1.

FIG. 3 is a circuit diagram illustrating a pixel of FIG. 1.

FIG. 4 is a timing diagram illustrating input signals applied to the pixel of FIG. 3.

FIG. 5 is a circuit diagram illustrating an operation of the pixel of FIG. 3 in a first period of FIG. 4.

FIG. 6 is a circuit diagram illustrating the input signals applied to the pixel of FIG. 3 in the first period of FIG. 4.

FIG. 7 is a circuit diagram illustrating an operation of the pixel of FIG. 3 in a second period of FIG. 4.

FIG. 8 is a circuit diagram illustrating the input signals applied to the pixel of FIG. 3 in the second period of FIG. 4.

FIG. 9 is a circuit diagram illustrating an operation of the pixel of FIG. 3 in a third period of FIG. 4.

FIG. 10 is a circuit diagram illustrating the input signals applied to the pixel of FIG. 3 in the third period of FIG. 4.

FIG. 11 is a circuit diagram illustrating an operation of the pixel of FIG. 3 in a fourth period of FIG. 4.

FIG. 12 is a circuit diagram illustrating the input signals applied to the pixel of FIG. 3 in the fourth period of FIG. 4.

FIG. 13 is a diagram illustrating a luminance of a pixel of a display panel according to a level of a pixel reference voltage in a comparative embodiment in which a first reference voltage and a second reference voltage are generated without feedback of the pixel reference voltage.

FIG. 14 is a diagram illustrating a luminance of a pixel of a display panel according to a level of a pixel reference voltage in some example embodiments in which a first reference voltage and a second reference voltage are generated using feedback of the pixel reference voltage.

FIG. 15 is a circuit diagram illustrating a gamma voltage control circuit of a display apparatus according to some example embodiments of the present inventive concepts.

FIG. 16 is a circuit diagram illustrating a pixel of a display panel of a display apparatus according to some example embodiments of the present inventive concepts.

FIG. 17 is a timing diagram illustrating input signals applied to the pixel of FIG. 16.

FIG. 18 is a circuit diagram illustrating an operation of the pixel of FIG. 16 in a first period of FIG. 17.

FIG. 19 is a circuit diagram illustrating the input signals applied to the pixel of FIG. 16 in the first period of FIG. 17.

FIG. 20 is a circuit diagram illustrating an operation of the pixel of FIG. 16 in a second period of FIG. 17.

FIG. 21 is a circuit diagram illustrating the input signals applied to the pixel of FIG. 16 in the second period of FIG. 17.

FIG. 22 is a circuit diagram illustrating an operation of the pixel of FIG. 16 in a third period of FIG. 17.

FIG. 23 is a circuit diagram illustrating the input signals applied to the pixel of FIG. 16 in the third period of FIG. 17.

FIG. 24 is a circuit diagram illustrating an operation of the pixel of FIG. 16 in a fourth period of FIG. 17.

FIG. 25 is a circuit diagram illustrating the input signals applied to the pixel of FIG. 16 in the fourth period of FIG. 17.

FIG. 26 is a circuit diagram illustrating an operation of the pixel of FIG. 16 in a fifth period of FIG. 17.

FIG. 27 is a circuit diagram illustrating the input signals applied to the pixel of FIG. 16 in the fifth period of FIG. 17.

FIG. 28 is a circuit diagram illustrating an operation of the pixel of FIG. 16 in a sixth period of FIG. 17.

FIG. 29 is a circuit diagram illustrating the input signals applied to the pixel of FIG. 16 in the sixth period of FIG. 17.

FIG. 30 is a circuit diagram illustrating an operation of the pixel of FIG. 16 in a seventh period of FIG. 17.

FIG. 31 is a circuit diagram illustrating the input signals applied to the pixel of FIG. 16 in the seventh period of FIG. 17.

FIG. 32 is a circuit diagram illustrating a pixel of a display panel of a display apparatus according to some example embodiments of the present inventive concepts.

FIG. 33 is a timing diagram illustrating input signals applied to the pixel of FIG. 32.

FIG. 34 is a circuit diagram illustrating an operation of the pixel of FIG. 32 in a first period of FIG. 33.

FIG. 35 is a circuit diagram illustrating the input signals applied to the pixel of FIG. 32 in the first period of FIG. 33.

FIG. 36 is a circuit diagram illustrating an operation of the pixel of FIG. 32 in a second period of FIG. 33.

FIG. 37 is a circuit diagram illustrating the input signals applied to the pixel of FIG. 32 in the second period of FIG. 33.

FIG. 38 is a circuit diagram illustrating an operation of the pixel of FIG. 32 in a third period of FIG. 33.

FIG. 39 is a circuit diagram illustrating the input signals applied to the pixel of FIG. 32 in the third period of FIG. 33.

FIG. 40 is a circuit diagram illustrating an operation of the pixel of FIG. 32 in a fourth period of FIG. 33.

FIG. 41 is a circuit diagram illustrating the input signals applied to the pixel of FIG. 32 in the fourth period of FIG. 33.

FIG. 42 is a circuit diagram illustrating an operation of the pixel of FIG. 32 in a fifth period of FIG. 33.

FIG. 43 is a circuit diagram illustrating the input signals applied to the pixel of FIG. 32 in the fifth period of FIG. 33.

FIG. 44 is a circuit diagram illustrating an operation of the pixel of FIG. 32 in a sixth period of FIG. 33.

FIG. 45 is a circuit diagram illustrating the input signals applied to the pixel of FIG. 32 in the sixth period of FIG. 33.

FIG. 46 is a circuit diagram illustrating an operation of the pixel of FIG. 32 in a seventh period of FIG. 33.

FIG. 47 is a circuit diagram illustrating the input signals applied to the pixel of FIG. 32 in the seventh period of FIG. 33.

FIG. 48 is a block diagram illustrating an electronic apparatus according to some example embodiments of the present inventive concepts.

FIG. 49 is a diagram illustrating an example in which the electronic apparatus of FIG. 48 is implemented as a smart phone.

FIG. 50 is a block diagram illustrating an electronic apparatus according to some example embodiments of the present inventive concepts.

FIG. 51 illustrates the electronic apparatus of FIG. 50 embodied in different electronic apparatuses.

### DETAILED DESCRIPTION OF EXAMPLE EMBODIMENTS

Hereinafter, some example embodiments of the present inventive concepts will be explained with reference to the accompanying drawings.

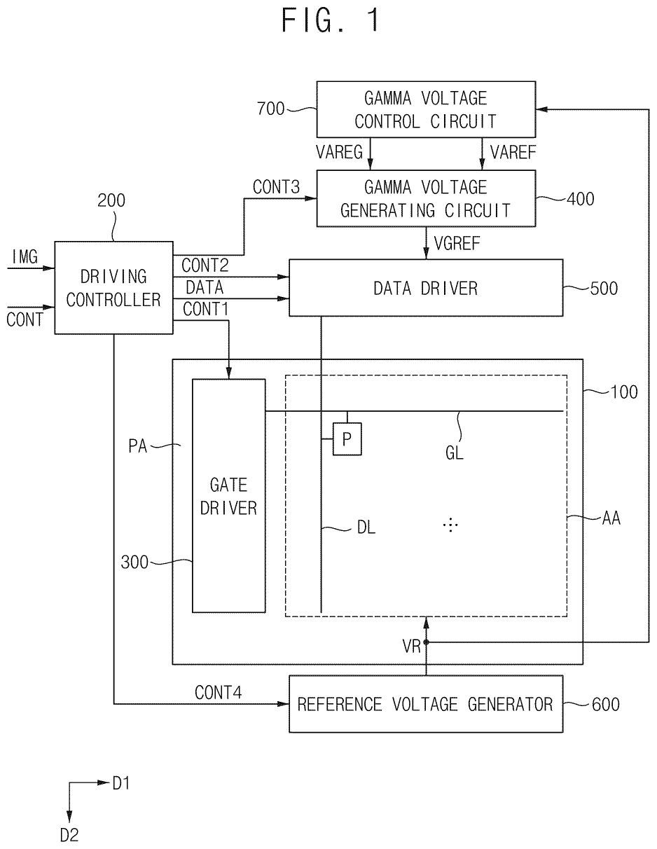

FIG. 1 is a block diagram illustrating a display apparatus according to some example embodiments of the present inventive concepts.

Referring to FIG. 1, the display apparatus includes a display panel 100 and a display panel driver. The display panel driver includes a driving controller 200, a gate driver 300, a gamma voltage generating circuit 400 and a data driver 500.

The display panel driver may further include a reference voltage generator 600 generating a pixel reference voltage VR applied (or input) to the display panel 100. The display panel driver may further include a gamma voltage control circuit 700 outputting a first reference voltage VAREG and a second reference voltage VAREF to the gamma voltage generating circuit 400.

The reference voltage generator 600 may apply (or input) the pixel reference voltage VR to the display panel 100. The pixel reference voltage VR may also be input to the gamma voltage control circuit 700. The pixel reference voltage VR may be input from the display panel 100 to the gamma voltage control circuit 700. Alternatively, the pixel reference voltage VR may be input to the gamma voltage control circuit 700 from a path between the reference voltage generator 600 and the display panel 100.

For example, the driving controller 200 and the data driver 500 may be integrally formed, for example, in a single semiconductor package. For example, the driving controller 200, the data driver 500 and the reference voltage generator 600 may be integrally formed, for example, in a single semiconductor package. For example, the driving controller 200, the gamma voltage generating circuit 400 and the data driver 500 may be integrally formed, for example, in a single semiconductor package. For example, the driving controller 200, the gamma voltage generating circuit 400, the data driver 500 and the gamma voltage control circuit 700 may be integrally formed, for example, in a single semiconductor package. For example, the driving controller 200, the gamma voltage generating circuit 400, the data driver 500, the reference voltage generator 600 and the gamma voltage control circuit 700 may be integrally formed, for example, in a single semiconductor package. A driving module including at least the driving controller 200 and the data driver 500 which are integrally formed may be referred to as a timing controller embedded data driver (TED).

The display panel 100 has a display region AA on which an image is displayed and a peripheral region PA adjacent to the display region AA.

The display panel 100 includes a plurality of gate lines GL, a plurality of data lines DL and a plurality of pixels P connected to the gate lines GL and the data lines DL, for example, connected at the intersections of the gate lines GL and the data lines DL. The gate lines GL may extend in a first direction D1 and the data lines DL may extend in a second direction D2 crossing the first direction D1.

The driving controller 200 receives input image data IMG and an input control signal CONT from an external apparatus (e.g., a processor). The input image data IMG may include red image data, green image data and blue image data. The input image data IMG may include white image data. The input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma voltage generating circuit 400 based on the input control signal CONT, and outputs the third control signal CONT3 to the gamma voltage generating circuit 400.

The gate driver 300 generates gate signals for driving the gate lines GL in response to the first control signal CONT1 received from the driving controller 200. The gate driver 300 outputs the gate signals to the gate lines GL. For example, the gate driver 300 may sequentially output the gate signals to the gate lines GL. In some example embodiments, the gate driver 300 may be mounted on the peripheral region PA of the display panel 100. In some example embodiments, the gate driver 300 may be integrated on the peripheral region PA of the display panel 100.

The gamma voltage generating circuit 400 generates a gamma voltage VGREF in response to the third control signal CONT3 received from the driving controller 200. The gamma voltage generating circuit 400 provides the gamma voltage VGREF to the data driver 500.

In some example embodiments, the gamma voltage generating circuit 400 may be disposed in the driving controller 200, or in the data driver 500.

The data driver 500 receives the second control signal CONT2 and the data signal DATA from the driving controller 200, and receives the gamma voltage VGREF from the gamma voltage generating circuit 400. The data driver 500 converts the data signal DATA into data voltages having an analog type using the gamma voltage VGREF. The data driver 500 outputs the data voltages to the data lines DL.

The reference voltage generator 600 may generate the pixel reference voltage VR in response to the fourth control signal CONT4 received from the driving controller 200. The reference voltage generator 600 outputs the pixel reference voltage VR to the pixels P of the display panel 100.

The gamma voltage control circuit 700 may generate the first reference voltage VAREG and the second reference voltage VAREF in which a change of the pixel reference voltage VR is reflected. The gamma voltage control circuit 700 may output the first reference voltage VAREG and the second reference voltage VAREF to the gamma voltage generating circuit 400.

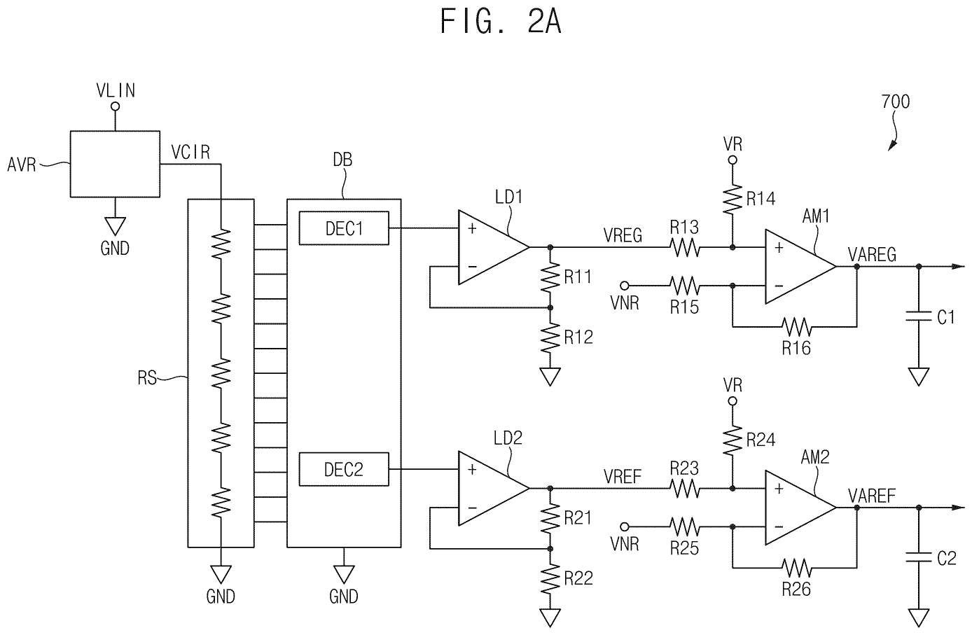

FIG. 2A is a circuit diagram illustrating the gamma voltage control circuit 700 of FIG. 1. FIG. 2B is a circuit diagram illustrating the gamma voltage generating circuit 400 of FIG. 1.

Referring to FIGS. 1 to 2B, the gamma voltage control circuit 700 includes a first amplifier AM1 generating the first reference voltage VAREG based on a first primitive reference voltage VREG, the pixel reference voltage VR received from the display panel 100 and an internal reference voltage VNR, and a second amplifier AM2 generating the second reference voltage VAREF based on a second primitive reference voltage VREF, the pixel reference voltage VR and the internal reference voltage VNR.

In some example embodiments, the internal reference voltage VNR may be generated in the gamma voltage control circuit 700. For example, the internal reference voltage VNR may be generated in the gamma voltage control circuit 700 using a VCIR voltage which is an analog reference voltage. The internal reference voltage VNR may have a value same as the pixel reference voltage VR. The internal reference voltage VNR may be a target voltage of the pixel reference voltage VR. When a level of the pixel reference voltage VR is changed due to a coupling, a noise, and other factors, a difference between the pixel reference voltage VR and the internal reference voltage VNR may be reflected in the first reference voltage VAREG through the first amplifier AM1. When the level of the pixel reference voltage VR is changed due to the coupling, the noise, and other factors, a difference between the pixel reference voltage VR and the internal reference voltage VNR may be reflected in the second reference voltage VAREF through the second amplifier AM2.

Herein, the first reference voltage VAREG may be a high reference voltage provided to the gamma voltage generating circuit 400 to generate the gamma voltage VGREF. The second reference voltage VAREF may be a low reference voltage provided to the gamma voltage generating circuit 400 to generate the gamma voltage VGREF. For example, the gamma voltage generating circuit 400 may generate the gamma voltage VGREF which has a value between the first reference voltage VAREG and the second reference voltage VAREF.

For example, the first reference voltage VAREG may correspond to a white grayscale value (which, for example, may be a voltage relatively closer to the white grayscale value). For example, the second reference voltage VAREF may correspond to a black grayscale value (which, for example, may be a voltage relatively closer to the black grayscale value). In contrast, in other instances, the first reference voltage VAREG may correspond to the black grayscale value (which, for example, may be a voltage relatively closer to the black grayscale value) and the second reference voltage VAREF may correspond to the white grayscale value (which, for example, may be a voltage relatively closer to the white grayscale value). When a driving transistor of the pixel is an N-type transistor, the first reference voltage VAREG may correspond to the white grayscale value (for example, the voltage relatively closer to the white grayscale value) and the second reference voltage VAREF may correspond to the black grayscale value (for example, the voltage relatively closer to the black grayscale value). In contrast, when the driving transistor of the pixel is a P-type transistor, the first reference voltage VAREG may correspond to the black grayscale value (for example, the voltage relatively closer to the black grayscale value) and the second reference voltage VAREF may correspond to the white grayscale value (for example, the voltage relatively closer to the white grayscale value).

In some example embodiments, the gamma voltage generating circuit 400 may generate some (e.g., one or more, but not all) of gamma voltages for all grayscale values and output the some (e.g., one or more, but not all) of the gamma voltages to the data driver 500 and the data driver 500 may generate all of the gamma voltages for all grayscale values using the some of the gamma voltages. In some example embodiments, the gamma voltage generating circuit 400 may generate all of the gamma voltages for all grayscale values and output all of the gamma voltages to the data driver 500.

The first amplifier AM1 may be a first differential amplifier. The first amplifier AM1 may include a non-inverting input terminal receiving the first primitive reference voltage VREG and the pixel reference voltage VR, an inverting input terminal receiving the internal reference voltage VNR and an output terminal outputting the first reference voltage VAREG.

The gamma voltage control circuit 700 may further include a third resistor R13 including a first end receiving the first primitive reference voltage VREG and a second end connected to the non-inverting input terminal of the first amplifier AM1, a fourth resistor R14 including a first end receiving the pixel reference voltage VR and a second end connected to the non-inverting input terminal of the first amplifier AM1, a fifth resistor R15 including a first end receiving the internal reference voltage VNR and a second end connected to the inverting input terminal of the first amplifier AM1 and a sixth resistor R16 including a first end connected to the inverting input terminal of the first amplifier AM1 and a second end connected to the output terminal of the first amplifier AM1. The gamma voltage control circuit 700 may further include a first capacitor C1 connected to the output terminal of the first amplifier AM1.

For example, in some example embodiments, the third resistor R13 and the fourth resistor R14 may have a same or similar resistance. For example, in some example embodiments, the fifth resistor R15 and the sixth resistor R16 may have a same or similar resistance.

The second amplifier AM2 may be a second differential amplifier. The second amplifier AM2 may include a non-inverting input terminal receiving the second primitive reference voltage VREF and the pixel reference voltage VR, an inverting input terminal receiving the internal reference voltage VNR and an output terminal outputting the second reference voltage VAREF.

The gamma voltage control circuit 700 may further include a ninth resistor R23 including a first end receiving the second primitive reference voltage VREF and a second end connected to the non-inverting input terminal of the second amplifier AM2, a tenth resistor R24 including a first end receiving the pixel reference voltage VR and a second end connected to the non-inverting input terminal of the second amplifier AM2, an eleventh resistor R25 including a first end receiving the internal reference voltage VNR and a second end connected to the inverting input terminal of the second amplifier AM2 and a twelfth resistor R26 including a first end connected to the inverting input terminal of the second amplifier AM2 and a second end connected to the output terminal of the second amplifier AM2. The gamma voltage control circuit 700 may further include a second capacitor C2 connected to the output terminal of the second amplifier AM2.

For example, in some example embodiments, the ninth resistor R23 and the tenth resistor R24 may have a same or similar resistance. For example, in some example embodiments, the eleventh resistor R25 and the twelfth resistor R26 may have a same or similar resistance.

The first reference voltage VAREG, the first primitive reference voltage VREG, the pixel reference voltage is VR and the internal reference voltage VNR may satisfy the relationship VAREG=VREG+VR−VNR. For example, the third resistor R13, the fourth resistor R14, the fifth resistor R15 and the sixth resistor R16 have a same resistance, and the first reference voltage VAREG, the first primitive reference voltage VREG, the pixel reference voltage VR and the internal reference voltage VNR may satisfy the relationship VAREG=VREG+VR−VNR.

The second reference voltage VAREF, the second primitive reference voltage VREF, the pixel reference voltage VR and the internal reference voltage VNR may satisfy the relationship VAREF=VREF+VR−VNR. For example, the ninth resistor R23, the tenth resistor R24, the eleventh resistor R25 and the twelfth resistor R26 have a same resistance, and the second reference voltage VAREF, the second primitive reference voltage VREF, the pixel reference voltage VR and the internal reference voltage VNR may satisfy the relationship VAREF=VREF+VR−VNR.

The gamma voltage control circuit 700 may further include a third amplifier LD1 generating the first primitive reference voltage VREG. The gamma voltage control circuit 700 may further include a resistor string RS and a first decoder DEC1. The resistor string RS may include a first end receiving the analog reference voltage VCIR. The first decoder DEC1 may be connected between the resistor string RS and the third amplifier LD1.

The gamma voltage control circuit 700 may further include an analog reference voltage generator AVR receiving an analog power voltage VLIN and generating the analog reference voltage VCIR. The gamma voltage control circuit 700 may receive the analog power voltage VLIN from a power voltage generator of the display panel driver. The power voltage generator may receive a battery voltage from a battery of an electronic apparatus. The power voltage generator may generate the analog power voltage VLIN based on the battery voltage. The power voltage generator may output the analog power voltage VLIN to the gamma voltage control circuit 700. The gamma voltage control circuit 700 may generate the analog reference voltage VCIR based on the analog power voltage VLIN.

The gamma voltage control circuit 700 may further include a fourth amplifier LD2 generating the second primitive reference voltage VREF. The gamma voltage control circuit 700 may further include a second decoder DEC2. The second decoder DEC2 may be connected between the resistor string RS and the fourth amplifier LD2.

The first decoder DEC1 and the second decoder DEC2 may be included in a decoder block DB. A second end of the resistor string RS may be connected to a ground. In addition, a first end of the decoder block DB may be connected to the ground.

For example, the third amplifier LD1 may be a first low dropout regulator. For example, the fourth amplifier LD2 may be a second low dropout regulator.

The third amplifier LD1 may include a non-inverting input terminal connected to the first decoder DEC1, an inverting input terminal, an output terminal outputting the first primitive reference voltage VREG, a first resistor R11 connected between the output terminal and the inverting input terminal and a second resistor R12 connected between the inverting input terminal and the ground.

The third amplifier LD1 may generate the first primitive reference voltage VREG by amplifying a first selected voltage outputted from the first decoder DEC1 with a first gain. The first primitive reference voltage VREG may be generated based on the analog reference voltage VCIR.

For example, the first gain may be determined by the first resistor R11 and the second resistor R12.

The fourth amplifier LD2 may include a non-inverting input terminal connected to the second decoder DEC2, an inverting input terminal, an output terminal outputting the second primitive reference voltage VREF, a seventh resistor R21 connected between the output terminal and the inverting input terminal and an eighth resistor R22 connected between the inverting input terminal and the ground.

The fourth amplifier LD2 may generate the second primitive reference voltage VREF by amplifying a second selected voltage outputted from the second decoder DEC2 with a second gain. The second primitive reference voltage VREF may be generated based on the analog reference voltage VCIR.

For example, the second gain may be determined by the seventh resistor R21 and the eighth resistor R22.

The gamma voltage generating circuit 400 may include a first gamma resistor string GRS1, a second gamma resistor string GRS2 and a plurality of gamma voltage setters VS11, VS12, VS13, VS21, VS22, VS23, . . . , VS2N.

The first reference voltage VAREG and the second reference voltage VAREF may be applied (or input) to the first gamma resistor string GRS1. The first gamma resistor string GRS1 may include a plurality of resistors which are connected to each other in series.

The gamma voltage generating circuit 400 may further include a 1-1 gamma voltage setter VS11 and a 1-1 gamma amplifier GAM11. The 1-1 gamma amplifier GAM11 may output a maximum gamma voltage VGREFM or a minimum gamma voltage VGREFM to the data driver 500. The 1-1 gamma amplifier GAM11 is not connected to the second gamma resistor string GRS2 to generate the maximum gamma voltage VGREFM or the minimum gamma voltage VGREFM having relatively higher stability.

The gamma voltage generating circuit 400 may further include a 1-2 gamma voltage setter VS12 and a 1-2 gamma amplifier GAM12. The 1-2 gamma amplifier GAM12 may output a first voltage to the second gamma resistor string GRS2.

The gamma voltage generating circuit 400 may further include a 1-3 gamma voltage setter VS13 and a 1-3 gamma amplifier GAM13. The 1-3 gamma amplifier GAM13 may output a second voltage to the second gamma resistor string GRS2.

The first voltage may be a high voltage of the second gamma resistor string GRS2. The second voltage may be a low voltage of the second gamma resistor string GRS2.

The first voltage and the second voltage which are extracted (or received) from the first gamma resistor string GRS1 may be applied to the second gamma resistor string GRS2.

The gamma voltage setters VS21, VS22, VS23, . . . , VS2N may extract (or receive) a plurality of gamma voltages VGREF1, VGREF2, VGREF3, . . . , VGREFN from the second gamma voltage string GRS. The gamma voltage generating circuit 400 may further include a plurality of gamma voltage output amplifiers GAM21, GAM22, GAM23, . . . , GAM2N connected to the gamma voltage setters VS21, VS22, VS23, . . . , VS2N, respectively.

The gamma voltage generating circuit 400 may include a red gamma voltage generating circuit corresponding to red input image data, a green gamma voltage generating circuit corresponding to green input image data and a blue gamma voltage generating circuit corresponding to blue input image data.

The gamma voltage generating circuit 400 may further include a plurality of output resistors RX1, RX2, . . . , RXN-1 connected between the gamma voltage output amplifiers GAM21, GAM22, GAM23, . . . , GAM2N.

The second gamma resistor string GRS2 may include a plurality of resistors which are connected to one another in series and output terminals disposed between the resistors.

For example, a voltage between the first voltage and the second voltage may be extracted from the second gamma resistor string GRS2 as a first gamma voltage VGREF1 by a voltage setting value applied to a 2-1 gamma voltage setter VS21. For example, a voltage between the first voltage and the second voltage may be extracted from the second gamma resistor string GRS2 as a second gamma voltage VGREF2 by a voltage setting value applied to a 2-2 gamma voltage setter VS22. For example, a voltage between the first voltage and the second voltage may be extracted from the second gamma resistor string GRS2 as a third gamma voltage VGREF3 by a voltage setting value applied to a 2-3 gamma voltage setter VS23. For example, a voltage between the first voltage and the second voltage may be extracted from the second gamma resistor string GRS2 as an N-th gamma voltage VGREFN by a voltage setting value applied to a 2-N gamma voltage setter VS2N.

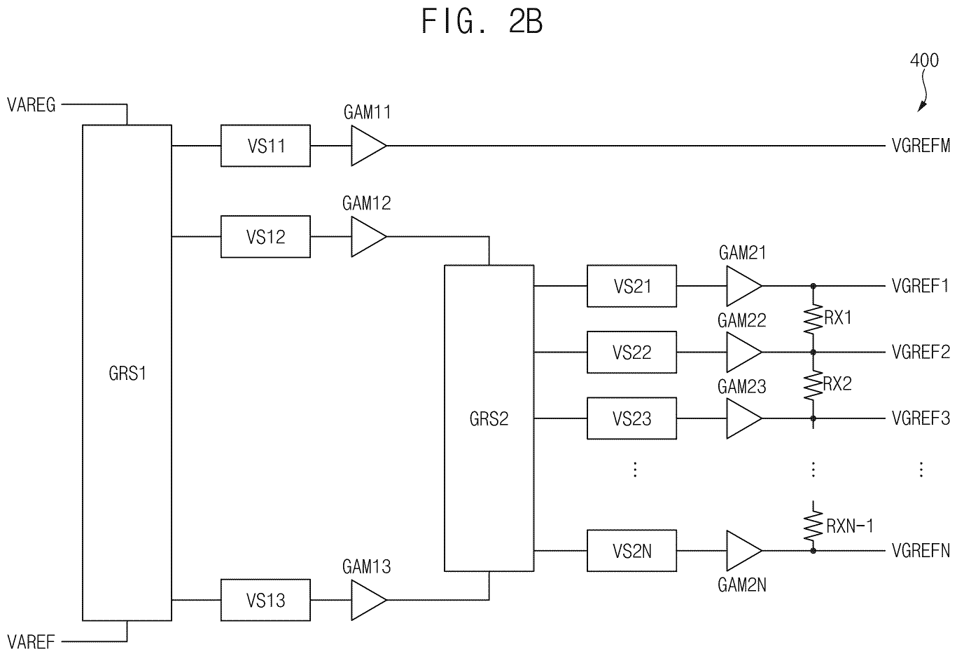

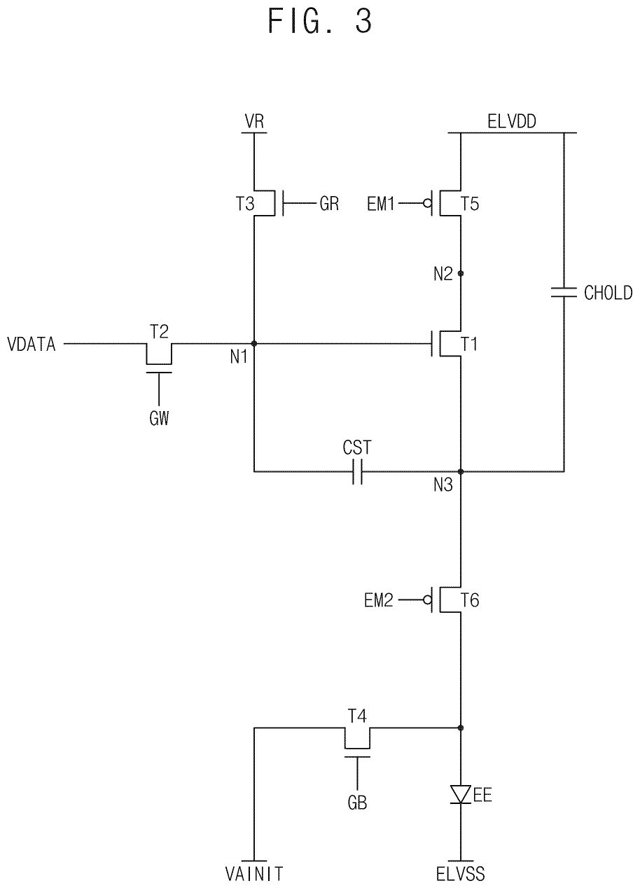

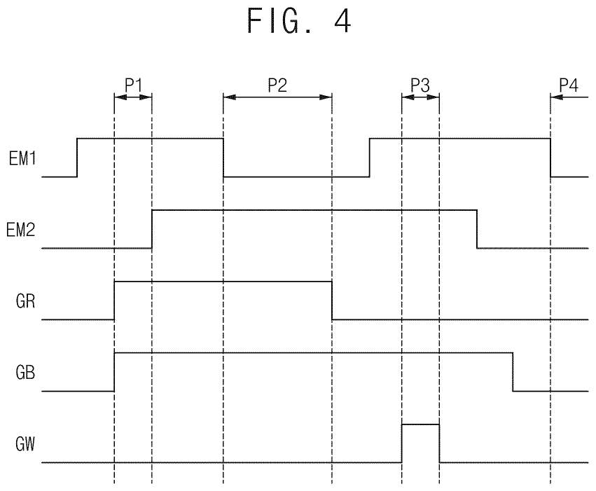

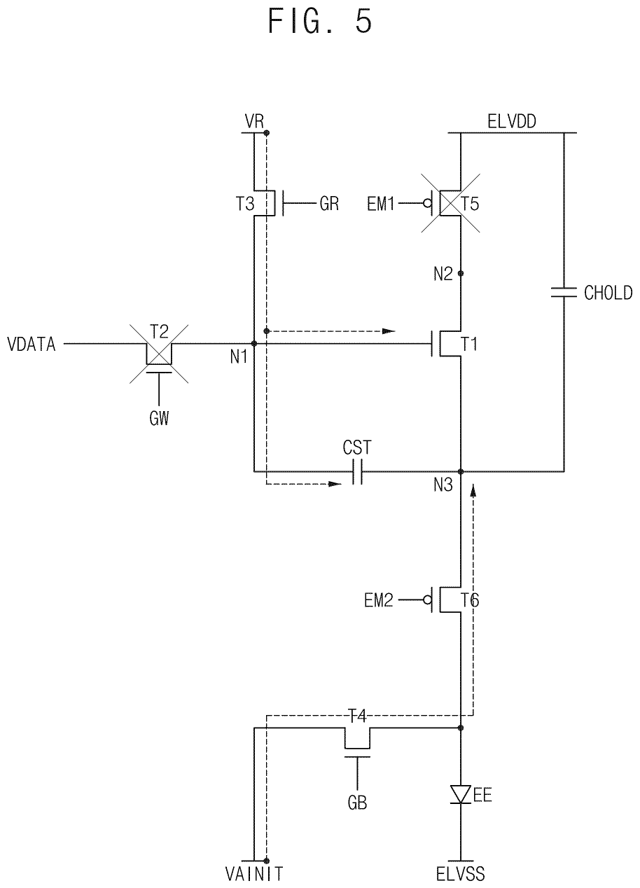

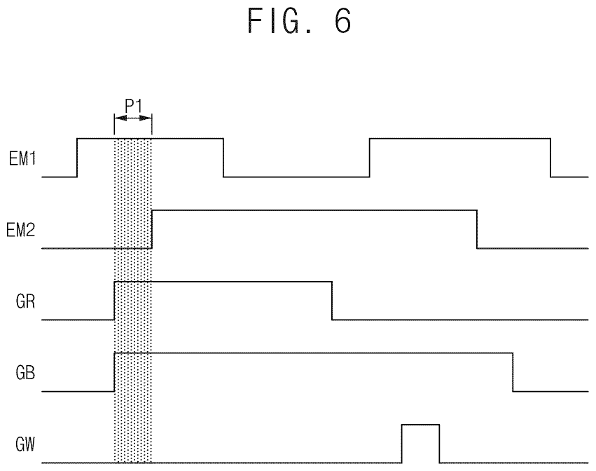

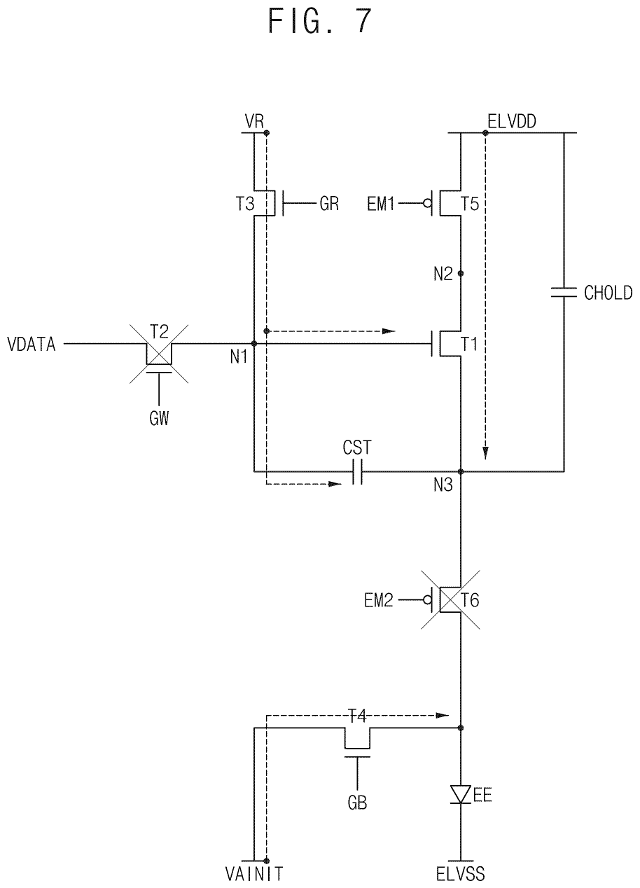

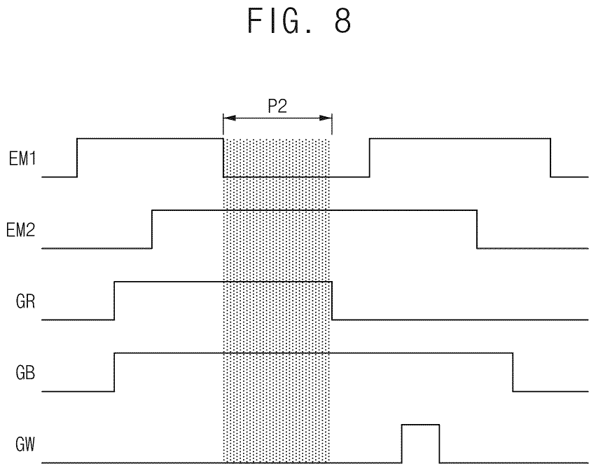

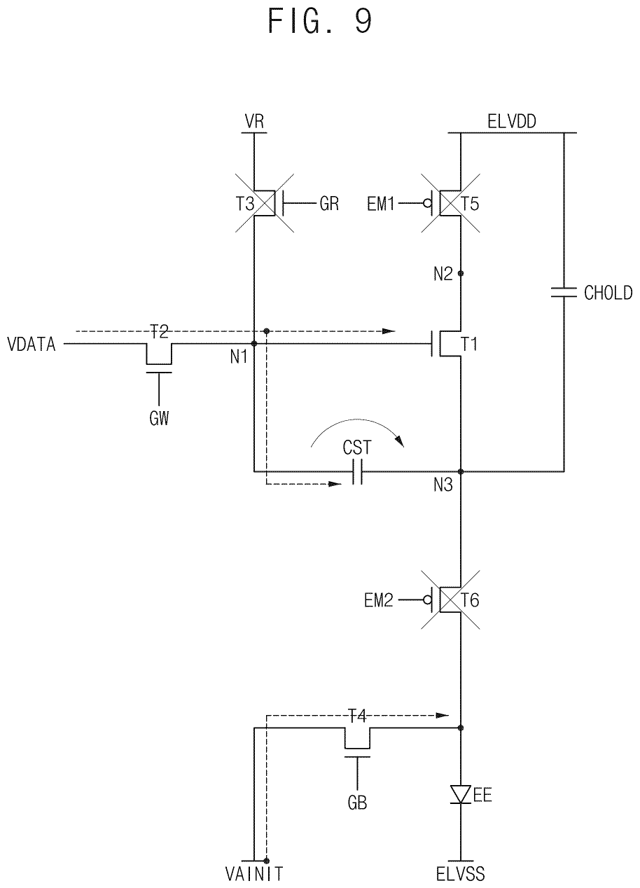

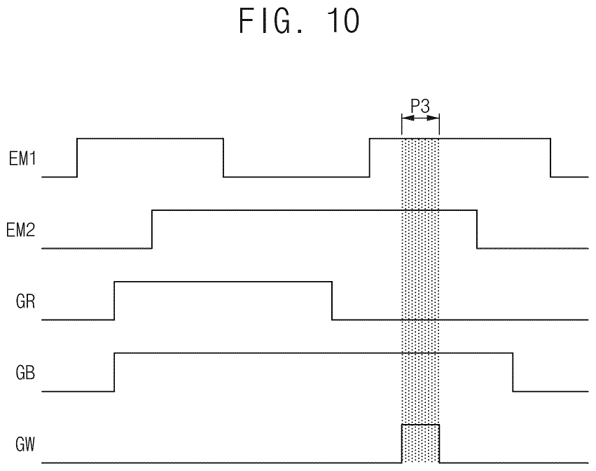

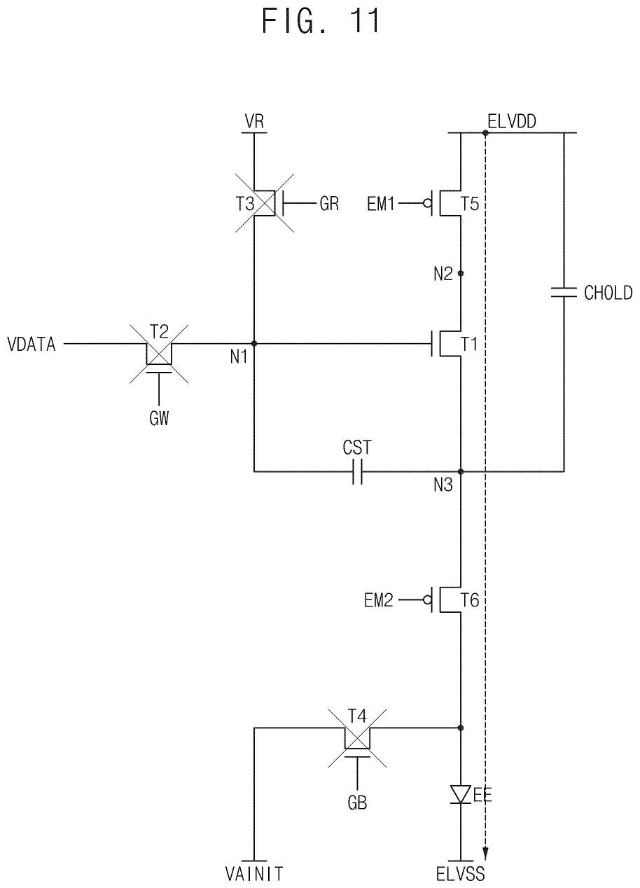

FIG. 3 is a circuit diagram illustrating a pixel P of FIG. 1. FIG. 4 is a timing diagram illustrating input signals applied to the pixel P of FIG. 3. FIG. 5 is a circuit diagram illustrating an operation of the pixel P of FIG. 3 in a first period P1 of FIG. 4. FIG. 6 is a circuit diagram illustrating the input signals applied to the pixel P of FIG. 3 in the first period P1 of FIG. 4. FIG. 7 is a circuit diagram illustrating an operation of the pixel P of FIG. 3 in a second period P2 of FIG. 4. FIG. 8 is a circuit diagram illustrating the input signals applied to the pixel P of FIG. 3 in the second period P2 of FIG. 4. FIG. 9 is a circuit diagram illustrating an operation of the pixel P of FIG. 3 in a third period P3 of FIG. 4. FIG. 10 is a circuit diagram illustrating the input signals applied to the pixel P of FIG. 3 in the third period P3 of FIG. 4. FIG. 11 is a circuit diagram illustrating an operation of the pixel P of FIG. 3 in a fourth period P4 of FIG. 4. FIG. 12 is a circuit diagram illustrating the input signals applied to the pixel P of FIG. 3 in the fourth period P4 of FIG. 4.

Referring to FIGS. 1 to 12, the pixel P may operate in response to a writing gate signal GW, a reference gate signal GR, a light emitting element initialization gate signal GB, a first emission signal EM1 and a second emission signal EM2. Herein, the reference gate signal GR may be referred to as a compensation gate signal. In some example embodiments, the writing gate signal GW, the reference gate signal GR, the light emitting element initialization gate signal GB, the first emission signal EM1, and the second emission signal EM2 may be generated by the gate driver 300 in response to the first control signal CONT1. In some example embodiments, the data driver 500 may generate a data voltage VDATA, a light emitting element initialization voltage VAINIT, a first power voltage ELVDD, and a second power voltage ELVSS based on the first reference voltage is VAREG, the second reference voltage is VAREF, and/or the gamma voltage VGREF, and based on the second control signal CONT2 and/or a data signal DATA.

A light emitting element EE of the pixel P emits a light based on a data voltage VDATA and the pixel reference voltage VR. A driving current of the light emitting element EE of the pixel P may be proportional to a square of a difference between the data voltage VDATA and the pixel reference voltage VR.

The pixel P may include the light emitting element EE, a first switching element T1 including a control electrode connected to a first node N1, a first electrode connected to a second node N2 and a second electrode connected to a third node N3, a second switching element T2 including a control electrode receiving the writing gate signal GW, a first electrode receiving the data voltage VDATA and a second electrode connected to the first node N1, a third switching element T3 including a control electrode receiving the reference gate signal GR, a first electrode receiving the pixel reference voltage VR and a second electrode connected to the first node N1, a fourth switching element T4 including a control electrode receiving the light emitting element initialization gate signal GB, a first electrode receiving a light emitting element initialization voltage VAINIT and a second electrode connected to an anode electrode of the light emitting element EE, a fifth switching element T5 including a control electrode receiving the first emission signal EM1, a first electrode receiving a first power voltage ELVDD and a second electrode connected to the second node N2 and a sixth switching element T6 including a control electrode receiving the second emission signal EM2, a first electrode connected to the third node N3 and a second electrode connected to the anode electrode of the light emitting element EE.

Herein, the first switching element T1 may be referred to as a driving switching element, the second switching element T2 may be referred to as a data writing switching element, the third switching element T3 may be referred to as a reference switching element and the first node N1 may be referred to as a data writing node.

The pixel P may further include a storage capacitor CST including a first electrode connected to the first node N1 and a second electrode connected to the third node N3.

The pixel P may further include a hold capacitor CHOLD including a first electrode receiving the first power voltage ELVDD and a second electrode connected to the third node N3.

The light emitting element EE may include a cathode electrode receiving a second power voltage ELVSS.

For example, the first power voltage ELVDD may be a high power voltage for a light emission of the light emitting element EE and the second power voltage ELVSS may be a low power voltage for the light emission of the light emitting element EE. The first power voltage ELVDD may be greater than the second power voltage ELVSS.

For example, the first switching element T1, the second switching element T2, the third switching element T3 and the fourth switching element T4 may be N-type transistors. The fifth switching element T5 and the sixth switching element T6 may be P-type transistors.

For example, the first switching element T1, the second switching element T2, the third switching element T3 and the fourth switching element T4 may be oxide semiconductor transistors. The fifth switching element T5 and the sixth switching element T6 may be low temperature polysilicon (LTPS) thin film transistors.

A driving timing of the pixel P may include a first period P1, a second period P2, a third period P3 and a fourth period P4. The first period P1 may be an initialization period. The second period P2 may be a threshold voltage compensation period. The third period P3 may be a writing period. The fourth period P4 may be a light emission period.

As shown in FIGS. 5 and 6, in the first period P1, the first emission signal EM1 may have an inactive level, the second emission signal EM2 may have an active level, the reference gate signal GR may have an active level and the writing gate signal GW may have an inactive level. In the first period P1, the light emitting element initialization gate signal GB may have an active level.

Herein, when the switching elements receiving the above signals are P-type transistors, active levels may be low levels and inactive levels may be high levels. In contrast, when the switching elements receiving the above signals are N-type transistors, active levels may be high levels and inactive levels may be low levels.

In the first period P1, the third switching element T3 may be turned on in response to the reference gate signal GR so that the pixel reference voltage VR may be applied to the first node N1.

In the first period P1, the fourth switching element T4 may be turned on in response to the light emitting element initialization gate signal GB and the sixth switching element T6 may be turned on in response to the second emission signal EM2 so that the light emitting element initialization voltage VAINIT may be applied to the anode electrode of the light emitting element EE and the third node N3.

As shown in FIGS. 7 and 8, in the second period P2 subsequent to the first period P1, the first emission signal EM1 may have an active level, the second emission signal EM2 may have an inactive level, the reference gate signal GR may have the active level, and the writing gate signal GW may have the inactive level. In the second period P2, the light emitting element initialization gate signal GB may have the active level.

In the second period P2, the third switching element T3 may be turned on (or may remain turned on from the first period P1) in response to the reference gate signal GR so that the pixel reference voltage VR may be applied to (or may remain applied to) the first node N1.

In the second period P2, the fourth switching element T4 may be turned on (or may remain turned on from the first period P1) in response to the light emitting element initialization gate signal GB so that the light emitting element initialization voltage VAINIT may be applied to (or may remain applied to) the anode electrode of the light emitting element EE.

In the second period P2, the fifth switching element T5 may be turned on in response to the first emission signal EM1 and the first switching element T1 may be turned on a voltage of the first node N1 so that the first power voltage ELVDD may be applied to the third node N3.

In the second period P2, a gate voltage of the first switching element T1 may be the pixel reference voltage VR, a source voltage of the first switching element T1 may be a difference VR-VTH between the pixel reference voltage VR and a threshold voltage of the first switching element T1 so that the threshold voltage of the first switching element T1 may be compensated.

As shown in FIGS. 9 and 10, in the third period P3 subsequent to the second period P2, the first emission signal EM1 may have the inactive level, the second emission signal EM2 may have the inactive level, the reference gate signal GR may have an inactive level and the writing gate signal GW may have an active level. In the third period P3, the light emitting element initialization gate signal GB may have the active level.

In the third period P3, the second switching element T2 may be turned on in response to the writing gate signal GW so that the data voltage VDATA may be applied to the first node N1.

When the data voltage VDATA is applied to the first node N1 in the third period P3, a change in the voltage of the first node N1 may be transmitted to the third node N3 by a coupling of the storage capacitor CST. When the change in the voltage of the first node N1 is transmitted to the third node N3 by the coupling of the storage capacitor CST, a voltage of the third node N3 may be determined according to a capacitance ratio of the storage capacitor CST and the hold capacitor CHOLD.

In the third period P3, the voltage of the first node N1 may be the data voltage VDATA. In the third period P3, the voltage of the third node N3 may be represented as

$$( VR - VTH ) + \frac{{c}_{S T}}{{c}_{S T + {C}_{H O L D}}} {( VDATA - VR )}^{2} .$$

Herein, C_{ST} may represent a capacitance of the storage capacitor C_{ST} and CHOLD may represent a capacitance of the hold capacitor CHOLD.

In the third period P3, the fourth switching element T4 may be turned on (or may remain turned on from the second period P2) in response to the light emitting element initialization gate signal GB so that the light emitting element initialization voltage VAINIT may be applied to (or may remain applied to) the anode electrode of the light emitting element EE.

As shown in FIGS. 11 and 12, in the fourth period P4 subsequent to the third period P3, the first emission signal EM1 may have the active level, the second emission signal EM2 may have the active level, the reference gate signal GR may have the inactive level and the writing gate signal GW may have the inactive level. In the fourth period P4, the light emitting element initialization gate signal GB may have an inactive level.

In the fourth period P4, the fifth switching element T5 may be turned on in response to the first emission signal EM1, the sixth switching element T6 may be turned on in response to the second emission signal EM2 and the first switching element T1 may be turned on (or may remain turned on from the third period P3) in response to the voltage of the first node N1 so that the driving current may flow along a path including the fifth switching element T5, the first switching element T1 and the sixth switching element T6.

In the fourth period P4, the light emitting element EE may emit light based on the driving current. As explained above, the driving current of the light emitting element EE may be proportional to the square of the difference between the data voltage VDATA and the pixel reference voltage VR.

The driving current in the fourth period P4 may be represented by Equation 1.

$$I = \frac{1}{2} μ {C}_{o x} \frac{W}{L} \frac{{C}_{S T}}{{C}_{S T} + {C}_{H O L D}} {( VDATA - VR )}^{2} \qquad [ Equation 1 ]$$

Herein, I represents the driving current, μ represents a mobility of the first switching element T1, Cₒₓ represents a capacitance per a unit area of the first switching element T1 and W/L may represent a ratio of a width and a length of a channel of the first switching element T1.

Equation I does not include a factor representative of the threshold voltage of the first switching element T1. Accordingly, it can be understood that the threshold voltage of the first switching element T1 is compensated. Alternatively, it may be understood that the driving current is not based on the threshold voltage of the first switching element T1.

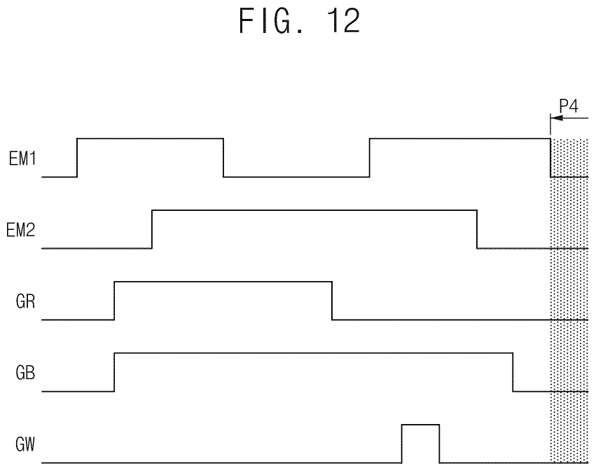

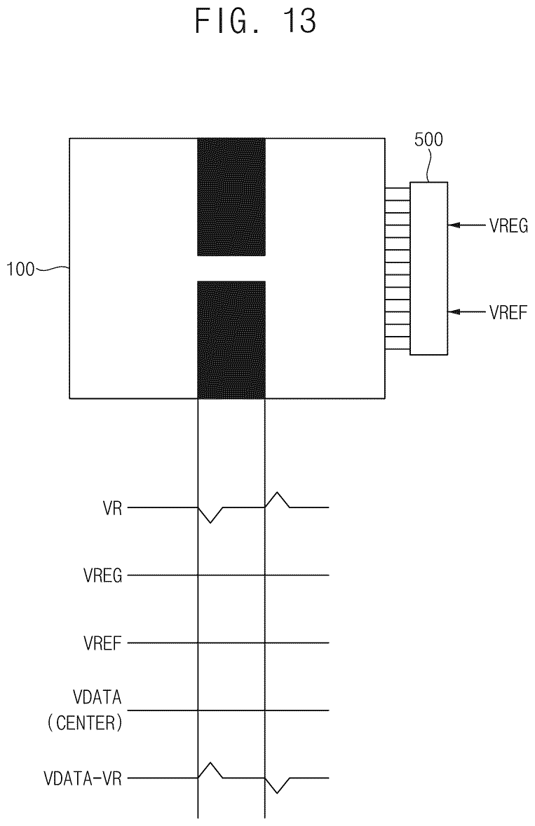

FIG. 13 is a diagram illustrating a luminance of a pixel P of a display panel 100 according to a level of a pixel reference voltage VR in a comparative embodiment in which a first reference voltage and a second reference voltage are generated without feedback of (or without being based on) the pixel reference voltage VR. FIG. 14 is a diagram illustrating a luminance of the pixel P of the display panel 100 according to a level of the pixel reference voltage VR in some example embodiments in which the first reference voltage VAREF and the second reference voltage VAREF are generated using feedback of (or are based on) the pixel reference voltage VR.

FIGS. 13 and 14 illustrate a case in which an image pattern for a crosstalk test is displayed on the display panel 100. FIG. 13 illustrates a waveform according to a conventional gamma voltage control circuit according to the comparative embodiment. FIG. 14 illustrates a waveform according to the gamma voltage control circuit 700 according to some example embodiments.

As shown in FIG. 13, the pixel reference voltage VR is not fed back, the first primitive reference voltage VREG and the second primitive reference voltage VREF may be output to the data driver 500 in the conventional gamma voltage control circuit according to the comparative embodiment.

In the comparative embodiment, the change of the pixel reference voltage VR may not be reflected in the first primitive reference voltage VREG and the second primitive reference voltage VREF.

In the conventional gamma voltage control circuit according to the comparative embodiment, the pixel reference voltage VR may be coupled to a change of the data voltage VDATA due to a change in an image pattern at a point when a white pattern changes into a black pattern so that a level of the pixel reference voltage VR may fluctuate.

The change of the pixel reference voltage VR is not reflected in the first primitive reference voltage VREG and the second primitive reference voltage VREF so that the data voltage VDATA may not be compensated despite the change of the pixel reference voltage VR. For example, the data voltage VDATA (CENTER) may have a constant value for an area corresponding to a white pattern disposed in a center of a black pattern.

Accordingly, the change of the pixel reference voltage VR may be reflected in the difference between the data voltage VDATA and the pixel reference voltage VR and the driving current of the light emitting element EE may be proportional to the square of the difference between the data voltage VDATA and the pixel reference voltage VR so that the pixel may display an undesired luminance.

Even at a point when the white pattern changes to the black pattern, the level of the pixel reference voltage VR may fluctuate for the same reason, and accordingly, the pixel may display an undesired luminance.

As shown in FIG. 14, the pixel reference voltage VR is fed back so that the gamma voltage control circuit 700 according to some example embodiments may generate the first reference voltage VAREG and the second reference voltage VAREF by reflecting the pixel reference voltage VR to the first primitive reference voltage VREG and the second primitive reference voltage VREF. The gamma voltage control circuit 700 may output the first reference voltage VAREG and the second reference voltage VAREF in which the pixel reference voltage VR is reflected in the data driver 500.

In the gamma voltage control circuit 700 according to some example embodiments, the pixel reference voltage VR may be coupled to a change of the data voltage VDATA due to a change in an image pattern at a point when a white pattern changes into a black pattern so that a level of the pixel reference voltage VR may fluctuate.

The change of the pixel reference voltage VR is reflected in the first reference voltage VAREG and the second reference voltage VAREF so that the data voltage VDATA may be compensated by the change of the pixel reference voltage VR. For example, the change of the pixel reference voltage VR may be reflected in the data voltage VDATA (CENTER) for an area corresponding to a white pattern disposed in a center of a black pattern.

Accordingly, the change of the pixel reference voltage VR may not affect the difference between the data voltage VDATA and the pixel reference voltage VR, the difference between the data voltage VDATA and the pixel reference voltage VR may be maintained constantly and the driving current of the light emitting element EE may be proportional to the square of the difference between the data voltage VDATA and the pixel reference voltage VR so that the pixel may display a desired luminance.

Even at a point when the white pattern changes to the black pattern, the difference between the data voltage VDATA and the pixel reference voltage VR may be maintained constantly for the same reason even though the level of the pixel reference voltage VR fluctuates, and accordingly, the pixel may display a desired luminance.

According to some example embodiments, the gamma voltage control circuit 700 may generate the first reference voltage VAREG and the second reference voltage VAREF using the pixel reference voltage VR fed back from the display panel 100.

Thus, the change of the pixel reference voltage VR may be reflected in the first reference voltage VAREG and the second reference voltage VAREF, the change of the pixel reference voltage VR may be reflected in the gamma voltage VGREF generated by the first reference voltage VAREG and the second reference voltage VAREF and the change of the pixel reference voltage VR may be reflected in the data voltage VDATA generated by the gamma voltage VGREF.

The change of the pixel reference voltage VR is reflected in the data voltage VDATA so that the crosstalk of the display panel 100 may be limited or reduced in a pixel structure in which the luminance of the light emitting element EE of the pixel P is determined based on the driving current proportional to the square of the difference between the data voltage VDATA and the pixel reference voltage VR.

In addition, when the level of the pixel reference voltage VR is changed according to a change of a driving condition such as a luminance, a frequency, a temperature, an image pattern and the like, the change of the pixel reference voltage VR may be reflected in the data voltage VDATA so that optical characteristics of the display panel 100 such as a luminance uniformity, a color uniformity, a flicker and the like may be improved or increased.

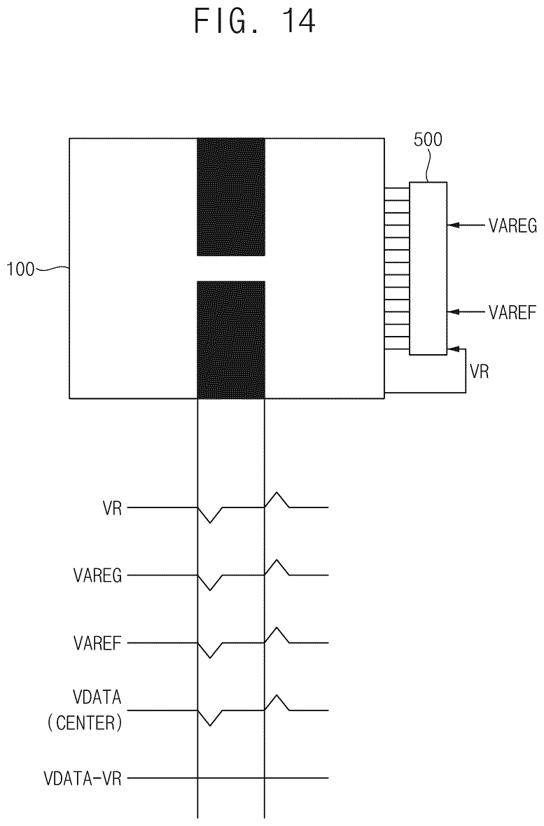

FIG. 15 is a circuit diagram illustrating a gamma voltage control circuit 700A of a display apparatus according to some example embodiments of the present inventive concepts.

The display apparatus according to some example embodiments is same as or similar in some respects to the display apparatus of FIGS. 1 to 14, and therefore may be best understood with reference thereto where like numerals indicate like elements not described again in detail.

Referring to FIGS. 1 and 3 to 15, the display apparatus includes a display panel 100 and a display panel driver. The display panel driver includes a driving controller 200, a gate driver 300, a gamma voltage generating circuit 400 and a data driver 500.

The display panel driver may further include a reference voltage generator 600 generating a pixel reference voltage VR applied to the display panel 100. The display panel driver may further include a gamma voltage control circuit 700A outputting a first reference voltage VAREG and a second reference voltage VAREF to the gamma voltage generating circuit 400.

The gamma voltage control circuit 700A may generate the first reference voltage VAREG and the second reference voltage VAREF in which a change of the pixel reference voltage VR is reflected. The gamma voltage control circuit 700A may output the first reference voltage VAREG and the second reference voltage VAREF to the gamma voltage generating circuit 400.

The gamma voltage control circuit 700A includes a first amplifier AM1 generating the first reference voltage VAREG based on a first primitive reference voltage VREG, the pixel reference voltage VR fed back (or received) from the display panel 100 and an internal reference voltage VNR and a second amplifier AM2 generating the second reference voltage VAREF based on a second primitive reference voltage VREF, the pixel reference voltage VR and the internal reference voltage VNR.

The internal reference voltage VNR may have a value same as the pixel reference voltage VR. The internal reference voltage VNR may be a target voltage of the pixel reference voltage VR. When a level of the pixel reference voltage VR is changed due to a coupling, a noise and so on, a difference between the pixel reference voltage VR and the internal reference voltage VNR may be reflected in the first reference voltage VAREG through the first amplifier AM1. When the level of the pixel reference voltage VR is changed due to the coupling, the noise and other factors, a difference between the pixel reference voltage VR and the internal reference voltage VNR may be reflected in the second reference voltage VAREF through the second amplifier AM2.

The gamma voltage control circuit 700A may further include a third amplifier LD1 generating the first primitive reference voltage VREG. The gamma voltage control circuit 700A may further include a resistor string RS and a first decoder DEC1. The resistor string RS may include a first end receiving the analog reference voltage VCIR. The first decoder DEC1 may be connected between the resistor string RS and the third amplifier LD1.

The gamma voltage control circuit 700A may further include a fourth amplifier LD2 generating the second primitive reference voltage VREF. The gamma voltage control circuit 700A may further include a second decoder DEC2. The second decoder DEC2 may be connected between the resistor string RS and the fourth amplifier LD2.

The third amplifier LD1 may be a first low dropout regulator. For example, the fourth amplifier LD2 may be a second low dropout regulator.

In some example embodiments, the gamma voltage control circuit 700A may further include a fifth amplifier LD3 generating the internal reference voltage VNR. The gamma voltage control circuit 700A may further include a third decoder DEC3. The third decoder DEC3 may be connected between the resistor string RS and the fifth amplifier LD3.

The fifth amplifier LD3 may include a non-inverting input terminal connected to the third decoder DEC3, an inverting input terminal, an output terminal outputting the internal reference voltage VNR, a thirteenth resistor R31 connected between the output terminal and the inverting input terminal and a fourteenth resistor R32 connected between the inverting input terminal and the ground.

The fifth amplifier LD3 may generate the internal reference voltage VNR by amplifying a third selected voltage outputted from the third decoder DEC3 with a third gain. The internal reference voltage VNR may be generated based on the analog reference voltage VCIR.

For example, the third gain may be determined by the thirteenth resistor R31 and the fourteenth resistor R32.

According to some example embodiments, the gamma voltage control circuit 700A may generate the first reference voltage VAREG and the second reference voltage VAREF using the pixel reference voltage VR fed back (or received) from the display panel 100.

Thus, the change of the pixel reference voltage VR may be reflected in the first reference voltage VAREG and the second reference voltage VAREF, the change of the pixel reference voltage VR may be reflected in the gamma voltage VGREF generated by the first reference voltage VAREG and the second reference voltage VAREF and the change of the pixel reference voltage VR may be reflected in the data voltage VDATA generated by the gamma voltage VGREF.

The change of the pixel reference voltage VR is reflected in the data voltage VDATA so that the crosstalk of the display panel 100 may be limited or reduced in a pixel structure in which the luminance of the light emitting element EE of the pixel P is determined based on the driving current proportional to the square of the difference between the data voltage VDATA and the pixel reference voltage VR.

In addition, when the level of the pixel reference voltage VR is changed according to a change of a driving condition such as a luminance, a frequency, a temperature, an image pattern and the like, the change of the pixel reference voltage VR may be reflected in the data voltage VDATA so that optical characteristics of the display panel 100 such as a luminance uniformity, a color uniformity, a flicker and the like may be increased or improved.

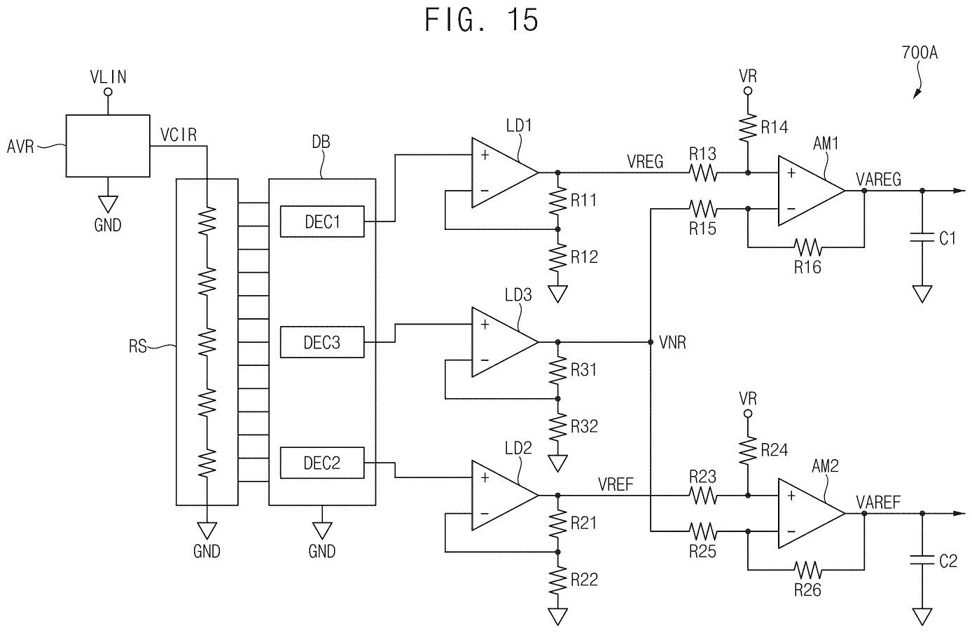

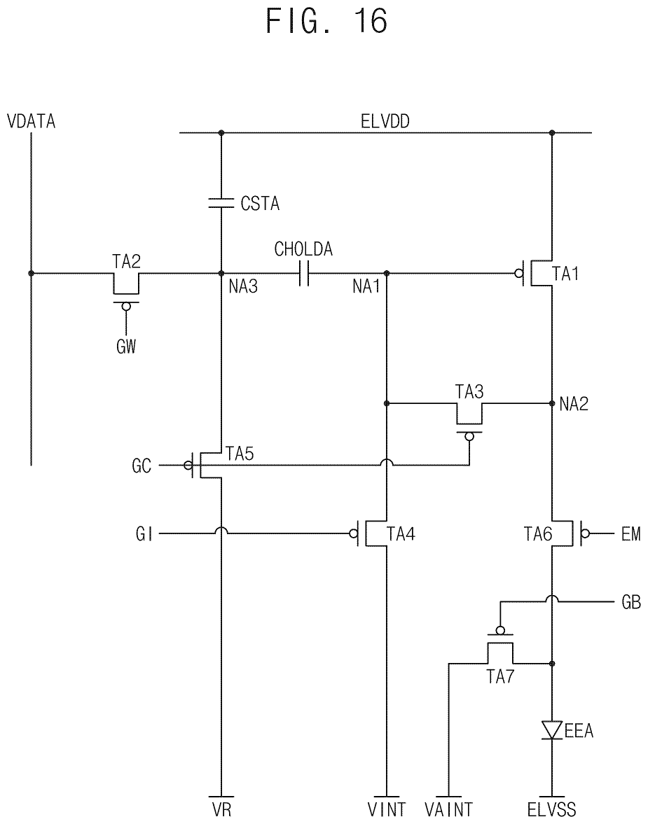

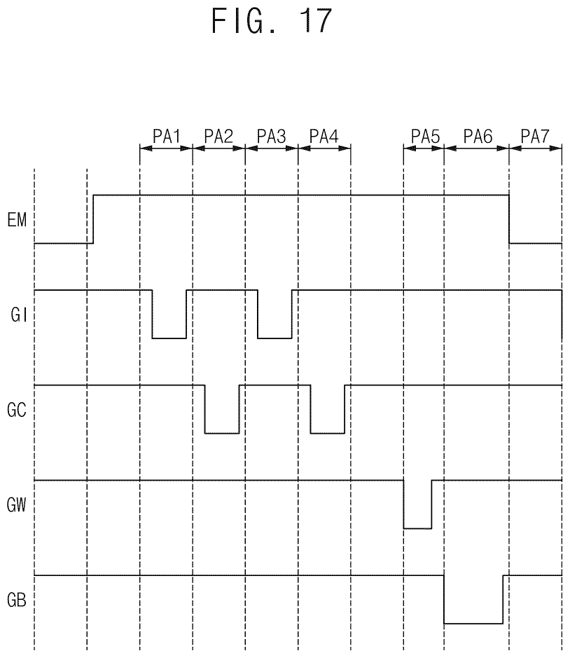

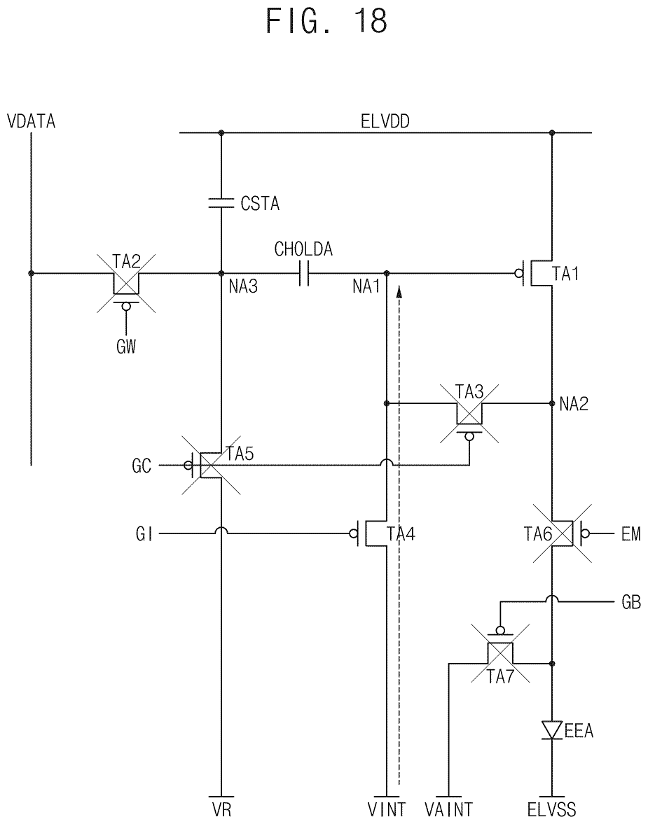

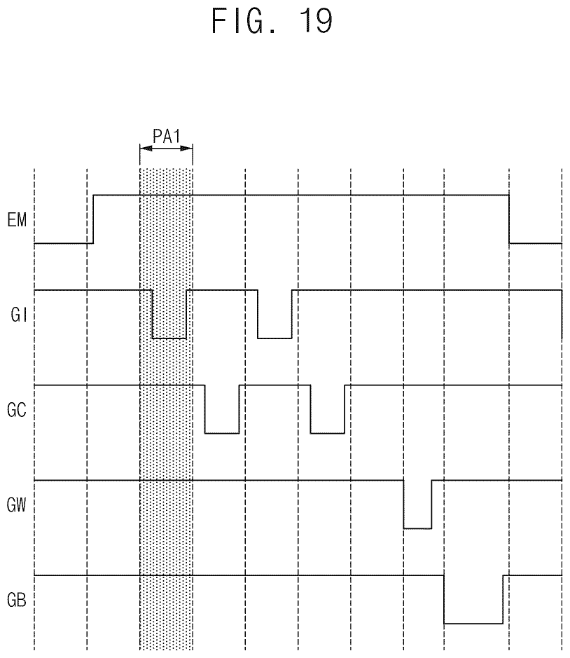

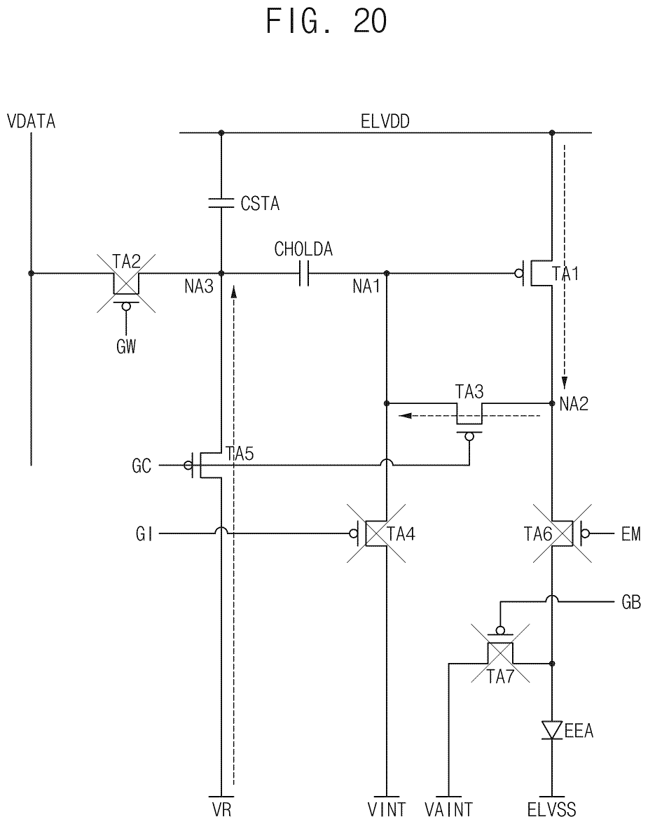

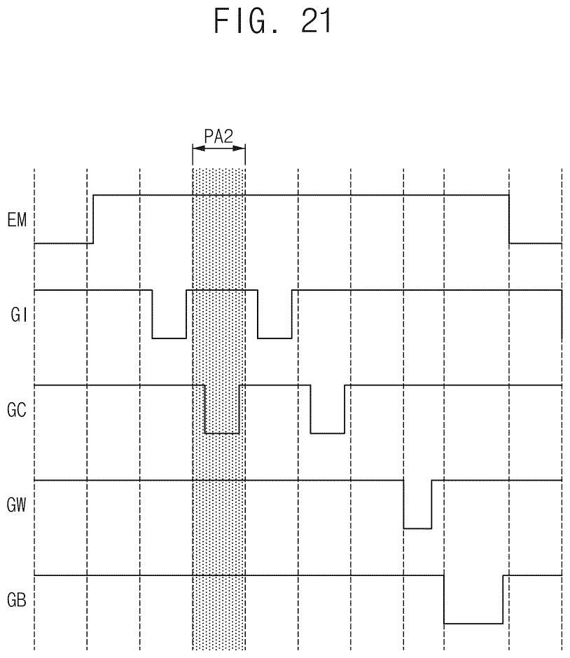

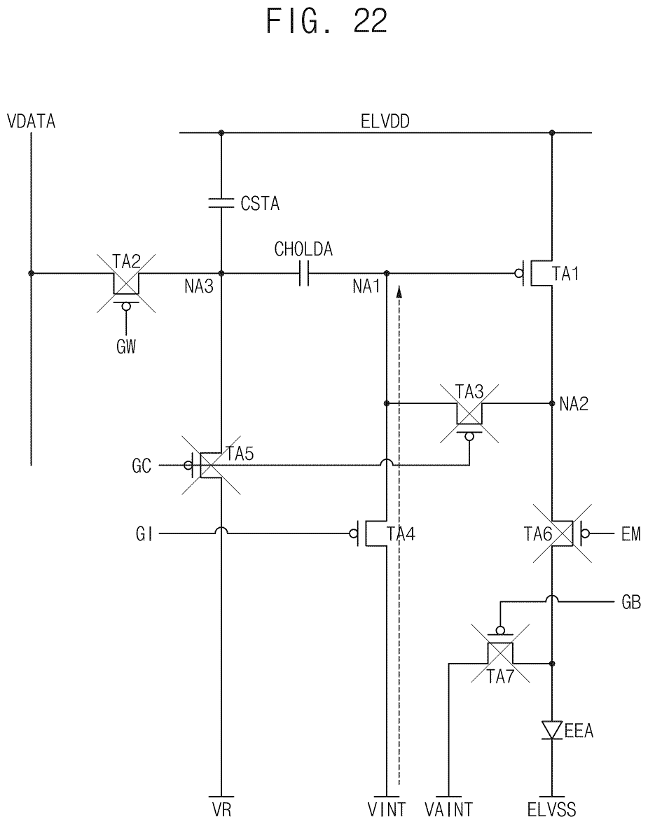

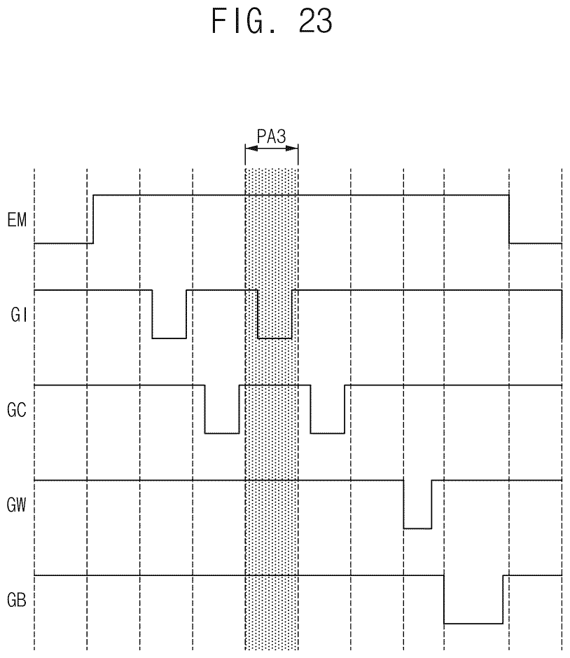

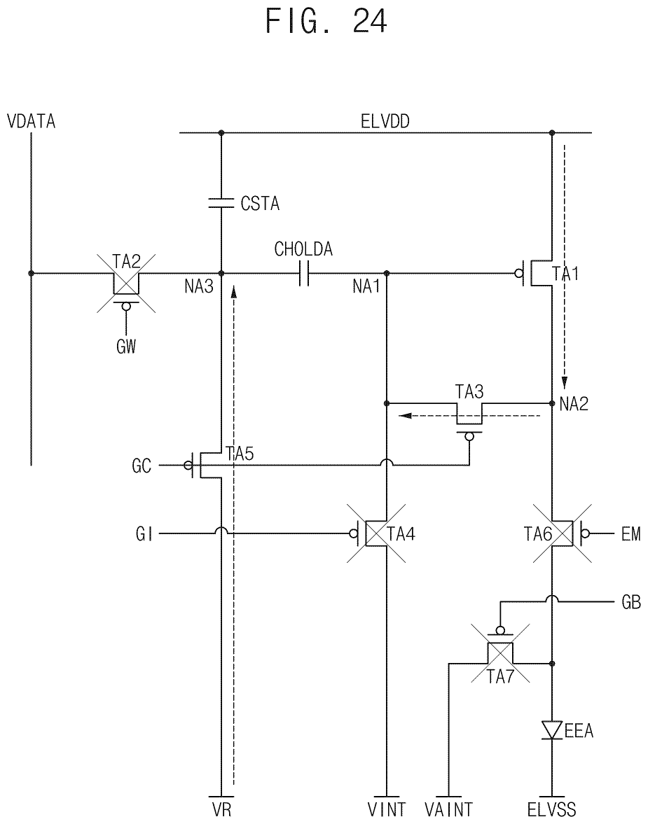

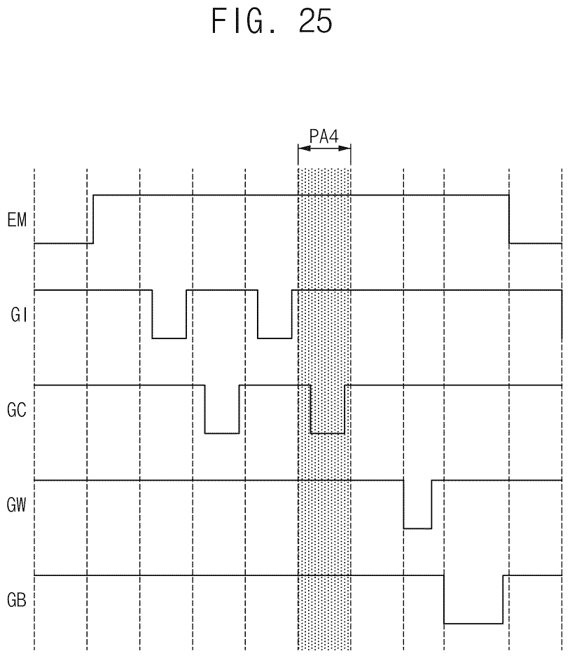

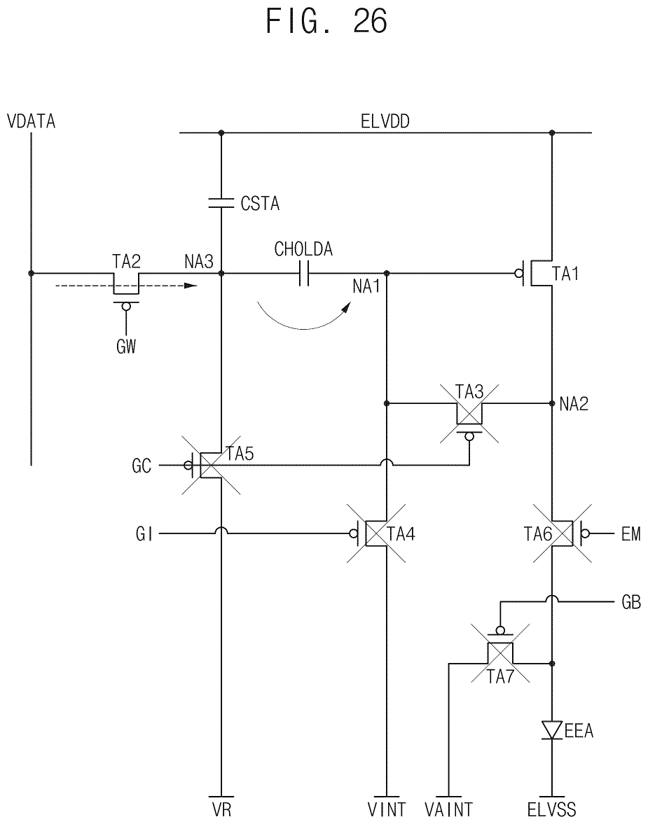

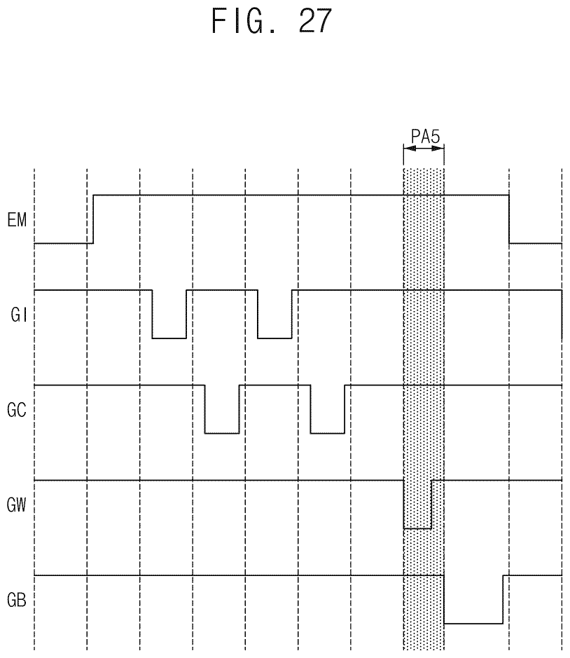

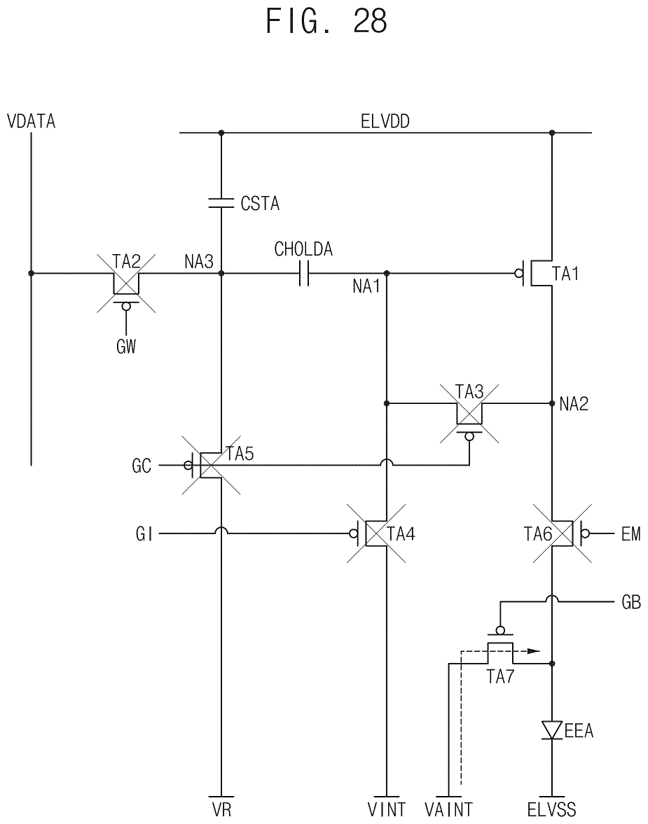

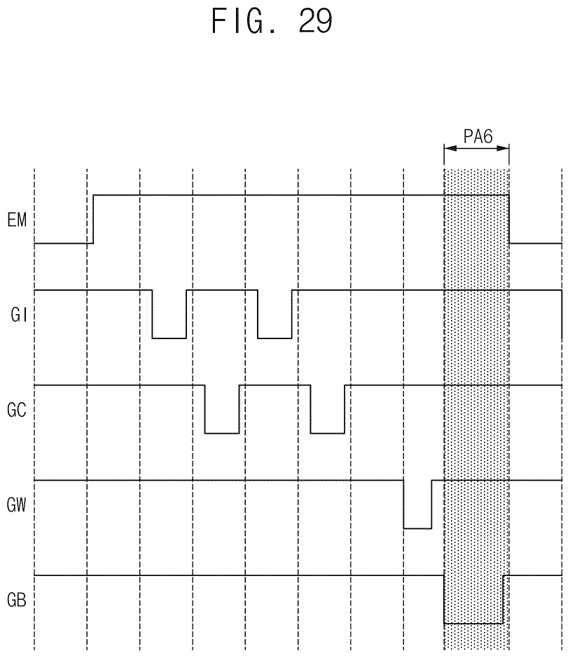

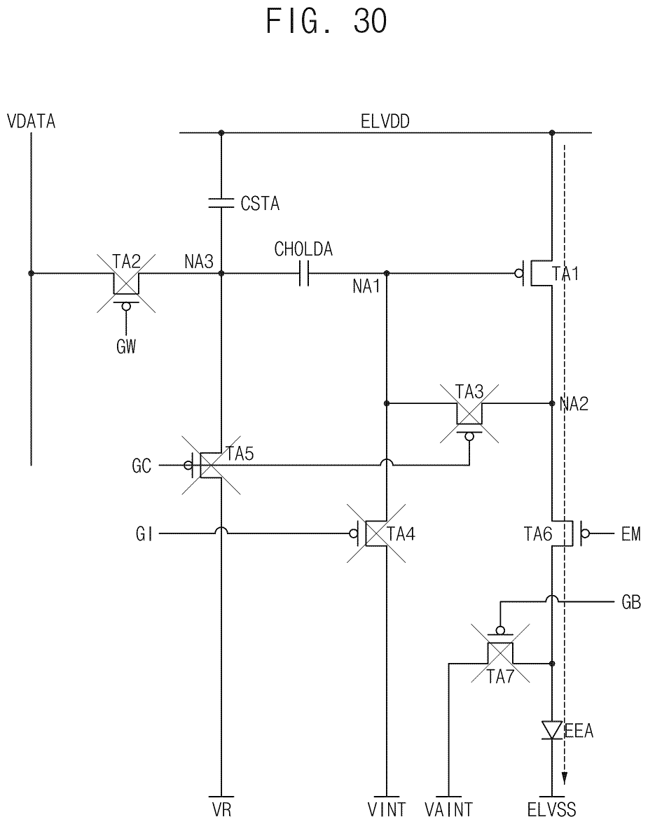

FIG. 16 is a circuit diagram illustrating a pixel P of a display panel 100 of a display apparatus according to some example embodiments of the present inventive concepts. FIG. 17 is a timing diagram illustrating input signals applied to the pixel P of FIG. 16. FIG. 18 is a circuit diagram illustrating an operation of the pixel P of FIG. 16 in a first period PA1 of FIG. 17. FIG. 19 is a circuit diagram illustrating the input signals applied to the pixel P of FIG. 16 in the first period PA1 of FIG. 17. FIG. 20 is a circuit diagram illustrating an operation of the pixel P of FIG. 16 in a second period PA2 of FIG. 17. FIG. 21 is a circuit diagram illustrating the input signals applied to the pixel P of FIG. 16 in the second period PA2 of FIG. 17. FIG. 22 is a circuit diagram illustrating an operation of the pixel P of FIG. 16 in a third period PA3 of FIG. 17. FIG. 23 is a circuit diagram illustrating the input signals applied to the pixel P of FIG. 16 in the third period PA3 of FIG. 17. FIG. 24 is a circuit diagram illustrating an operation of the pixel P of FIG. 16 in a fourth period PA4 of FIG. 17. FIG. 25 is a circuit diagram illustrating the input signals applied to the pixel P of FIG. 16 in the fourth period PA4 of FIG. 17. FIG. 26 is a circuit diagram illustrating an operation of the pixel P of FIG. 16 in a fifth period PA5 of FIG. 17. FIG. 27 is a circuit diagram illustrating the input signals applied to the pixel P of FIG. 16 in the fifth period PA5 of FIG. 17. FIG. 28 is a circuit diagram illustrating an operation of the pixel P of FIG. 16 in a sixth period PA6 of FIG. 17. FIG. 29 is a circuit diagram illustrating the input signals applied to the pixel P of FIG. 16 in the sixth period PA6 of FIG. 17. FIG. 30 is a circuit diagram illustrating an operation of the pixel P of FIG. 16 in a seventh period PA7 of FIG. 17. FIG. 31 is a circuit diagram illustrating the input signals applied to the pixel P of FIG. 16 in the seventh period PA7 of FIG. 17.

The display apparatus referenced in FIGS. 16-31, according to some example embodiments, may be same as or similar in some respects to the display apparatus of FIGS. 1 to 14, and therefore may be best understood with reference thereto where like numerals indicate like elements not described again in detail.

Referring to FIGS. 1, 2A, 2B, 13, 14 and 16 to 31, the display apparatus includes a display panel 100 and a display panel driver. The display panel driver includes a driving controller 200, a gate driver 300, a gamma voltage generating circuit 400 and a data driver 500.

The display panel driver may further include a reference voltage generator 600 generating a pixel reference voltage VR applied to the display panel 100. The display panel driver may further include a gamma voltage control circuit 700 outputting a first reference voltage VAREG and a second reference voltage VAREF to the gamma voltage generating circuit 400.

The gamma voltage control circuit 700 may generate the first reference voltage VAREG and the second reference voltage VAREF in which a change of the pixel reference voltage VR is reflected. The gamma voltage control circuit 700 may output the first reference voltage VAREG and the second reference voltage VAREF to the gamma voltage generating circuit 400.

The pixel P (FIG. 16) may operate in response to an initialization gate signal GI, a compensation gate signal GC, a writing gate signal GW, a light emitting element initialization gate signal GB and an emission signal EM. Herein, the compensation gate signal GC may be referred to as a reference gate signal. In some example embodiments, the initialization gate signal GI, the compensation gate signal GC, the writing gate signal GW, the light emitting element initialization gate signal GB, and the emission signal EM may be generated by the gate driver 300 in response to the first control signal CONT1. In some example embodiments, the data driver 500 may generate a data voltage VDATA, a light emitting element initialization voltage VAINT, an initialization voltage VINT, a first power voltage ELVDD, and a second power voltage ELVSS based on the first reference voltage is VAREG, the second reference voltage is VAREF, and/or the gamma voltage VGREF, and based on the second control signal CONT2 and/or a data signal DATA.

A light emitting element EEA of the pixel P emits a light based on the data voltage VDATA and the pixel reference voltage VR. A driving current of the light emitting element EEA of the pixel P may be proportional to a square of a difference between the data voltage VDATA and the pixel reference voltage VR.

The pixel P may include the light emitting element EEA, a first switching element TA1 including a control electrode connected to a first node NA1, a first electrode receiving a first power voltage ELVDD and a second electrode connected to a second node NA2, a second switching element TA2 including a control electrode receiving the writing gate signal GW, a first electrode receiving the data voltage VDATA and a second electrode connected to a third node NA3, a third switching element TA3 including a control electrode receiving the compensation gate signal GC, a first electrode connected to the first node NA1 and a second electrode connected to the second node NA2, a fourth switching element TA4 including a control electrode receiving the initialization gate signal GI, a first electrode receiving an initialization voltage VINT and a second electrode connected to the first node NA1, a fifth switching element TA5 including a control electrode receiving the compensation gate signal GC, a first electrode receiving the pixel reference voltage VR and a second electrode connected to the third node NA3, a sixth switching element TA6 including a control electrode receiving the emission signal EM, a first electrode connected to the second node NA2 and a second electrode connected to an anode electrode of the light emitting element EEA and a seventh switching element TA7 including a control electrode receiving the light emitting element initialization gate signal GB, a first electrode receiving a light emitting element initialization voltage VAINT and a second electrode connected to the anode electrode of the light emitting element EEA.

Herein, the first switching element TA1 may be referred to as a driving switching element, the second switching element TA2 may be referred to as a data writing switching element, the fifth switching element TA5 may be referred to as a reference switching element and the third node NA3 may be referred to as a data writing node.

The pixel P may further include a hold capacitor CHOLDA including a first electrode connected to the first node NA1 and a second electrode connected to the third node NA3.

The pixel P may further include a storage capacitor CSTA including a first electrode receiving the first power voltage ELVDD and a second electrode connected to the third node NA3.

The light emitting element EEA may include a cathode electrode receiving a second power voltage ELVSS.

For example, the first power voltage ELVDD may be a high power voltage for a light emission of the light emitting element EEA and the second power voltage ELVSS may be a low power voltage for the light emission of the light emitting element EEA. The first power voltage ELVDD may be greater than the second power voltage ELVSS.

For example, the first switching element TA1, the second switching element TA2, the third switching element TA3, the fourth switching element TA4, the fifth switching element TA5, the sixth switching element TA6 and the seventh switching element TA7 may be P-type transistors.

For example, the first switching element TA1, the second switching element TA2, the third switching element TA3, the fourth switching element TA4, the fifth switching element TA5, the sixth switching element TA6 and the seventh switching element TA7 may be low temperature polysilicon (LTPS) thin film transistors.

A driving timing of the pixel P may include a first period PA1, a second period PA2, a third period PA3, a fourth period PA4, a fifth period PA5, a sixth period PA6 and a seventh period PA7. The first period PA1 may be an initialization period. The second period PA2 may be a threshold voltage compensation period. The third period PA3 may be a second initialization period. The fourth period PA4 may be a second threshold voltage compensation period. The fifth period PA5 may be a writing period. The sixth period PA6 may be a light emitting element initialization period. The seventh period PA7 may be a light emission period.

As shown in FIGS. 18 and 19, in the initialization period PA1, the emission signal EM may have an inactive level, the initialization gate signal GI may have an active level, the compensation gate signal GC may have an inactive level and the writing gate signal GW may have an inactive level. In the initialization period PA1, the light emitting element initialization gate signal GB may have an inactive level. Alternatively, in the initialization period PA1, the light emitting element initialization gate signal GB may have an active level.

In some example embodiments, the switching elements receiving the above signals are all P-type transistors so that active levels may be low levels and inactive levels may be high levels.

In the initialization period PA1, the fourth switching element TA4 may be turned on in response to the initialization gate signal GI so that the initialization voltage VINT may be applied to the first node NA1.

In the initialization period PA1, a voltage of the third node NA3 may be a previous data signal.

As shown in FIGS. 20 and 21, in the threshold voltage compensation period PA2 subsequent to the initialization period PA1, the emission signal EM may have (or maintain) the inactive level, the initialization gate signal GI may have an inactive level, the compensation gate signal GC may have an active level and the writing gate signal GW may have (or maintain) the inactive level. In the threshold voltage compensation period PA2, the light emitting element initialization gate signal GB may have (or maintain) the inactive level. Alternatively, in the threshold voltage compensation period PA2, the light emitting element initialization gate signal GB may have the active level.

In the threshold voltage compensation period PA2, the fifth switching element TA5 may be turned on in response to the compensation gate signal GC so that the pixel reference voltage VR may be applied to the third node NA3.

In the threshold voltage compensation period PA2, the third switching element TA3 may be turned on in response to the compensation gate signal GC, the first switching element TA1 may be turned on (or may remain on from the initialization period PA1) in response to a voltage of the first node NA1 so that a voltage obtained by subtracting a threshold voltage of the first switching element TA1 from the first power voltage ELVDD may be applied to the second node NA2 and the first node NA1.

For example, in the compensation period PA2, a gate voltage of the first switching element TA1 may be a difference ELVDD-VTH between the first power voltage and the threshold voltage of the first switching element TA1, a source voltage of the first switching element TA1 may be the first power voltage ELVDD so that the threshold voltage of the first switching element TA1 may be compensated.

However, in the compensation period PA2, the gate voltage of the first switching element TA1 may be influenced by previous data.

As shown in FIGS. 22 and 23, in the second initialization period PA3, the emission signal EM may have (or maintain) the inactive level, the initialization gate signal GI may have the active level, the compensation gate signal GC may have the inactive level and the writing gate signal GW may have (or maintain) the inactive level. In the second initialization period PA3, the light emitting element initialization gate signal GB may have (or maintain) the inactive level. Alternatively, in the second initialization period PA3, the light emitting element initialization gate signal GB may have the active level.

In the second initialization period PA3, the fourth switching element TA4 may be turned on in response to the initialization gate signal GI so that the initialization voltage VINT may be applied to the first node NA1.

In the second initialization period PA3, the voltage of the third node NA3 may be the pixel reference voltage VR.

As shown in FIGS. 24 and 25, in the second compensation period PA4 subsequent to the second initialization period PA3, the emission signal EM may have (or maintain) the inactive level, the initialization gate signal GI may have the inactive level, the compensation gate signal GC may have the active level and the writing gate signal GW may have (or maintain) the inactive level. In the second compensation period PA4, the light emitting element initialization gate signal GB may have (or maintain) the inactive level. Alternatively, in the second compensation period PA4, the light emitting element initialization gate signal GB may have the active level.

In the second compensation period PA4, the fifth switching element TA5 may be turned on in response to the compensation gate signal GC so that the pixel reference voltage VR may be applied to the third node NA3.

In the second compensation period PA4, the third switching element TA3 may be turned on in response to the compensation gate signal GC, the first switching element TA1 may be turned on (or may remain turned on from the second initialization period PA3) in response to a voltage of the first node NA so that the voltage obtained by subtracting the threshold voltage of the first switching element TA1 from the first power voltage ELVDD may be applied to the second node NA2 and the first node NA1.

For example, in the second compensation period PA4, the gate voltage of the first switching element TA1 may be the difference ELVDD-VTH between the first power voltage and the threshold voltage of the first switching element TA1, the source voltage of the first switching element TA1 may be the first power voltage ELVDD so that the threshold voltage of the first switching element TA1 may be compensated.

In the second compensation period PA4, the influence of the previous data may be reduced or limited from the gate voltage of the first switching element TA1 so that the threshold voltage of the first switching element TA1 may be compensated with a relatively higher reliability.

As shown in FIGS. 26 and 27, in the writing period PA5 subsequent to the second compensation period PA4, the emission signal EM may have (or maintain) the inactive level, the initialization gate signal GI may have (or maintain) the inactive level, the compensation gate signal GC may have the inactive level and the writing gate signal GW may have an active level. In the writing period PA5, the light emitting element initialization gate signal GB may have (or maintain) the inactive level. Alternatively, in the writing period PA5, the light emitting element initialization gate signal GB may have the active level.

In the writing period PA5, the second switching element TA2 may be turned on in response to the writing gate signal GW so that the data voltage VDATA may be applied to the third node NA3 and the data voltage VDATA applied to the third node NA3 may be transmitted to the first node NA1 by a coupling of the hold capacitor CHOLDA.

For example, a voltage change (e.g., VDATA-VR) of the third node NA3 may be transmitted to the first node NA1 by the coupling of the hold capacitor CHOLDA. In the writing period PA5, the voltage of the third node NA3 may be VDATA, the gate voltage (the voltage of the first node NA1) of the first switching element TA1 may be ELVDD-VTH+(VDATA-VR) and the source voltage of the first switching element TA1 may be ELVDD.

As shown in FIGS. 28 and 29, in the light emitting element initialization period PA6 subsequent to the writing period PA5, the emission signal EM may have (or maintain) the inactive level, the initialization gate signal GI may have (or maintain) the inactive level, the compensation gate signal GC may have (or maintain) the inactive level and the writing gate signal GW may have the inactive level. In the light emitting element initialization period PA6, the light emitting element initialization gate signal GB may have the active level.

In the light emitting element initialization period PA6, the seventh switching element TA7 may be turned on in response to the light emitting element initialization gate signal GB so that the light emitting element initialization voltage VAINT may be applied to the anode electrode of the light emitting element EEA.

As shown in FIGS. 30 and 31, in the light emission period PA7 subsequent to the light emitting element initialization period PA6, the emission signal EM may have an active level, the initialization gate signal GI may have (or maintain) the inactive level, the compensation gate signal GC may have (or maintain) the inactive level and the writing gate signal GW may have (or maintain) the inactive level. In the light emission period PA7, the light emitting element initialization gate signal GB may have the inactive level.

In the light emission period PA7, the sixth switching element TA6 may be turned on in response to the emission signal EM and the first switching element TA1 may be turned on in response to the voltage of the first node NA so that the driving current may flow along a path including the first switching element TA1 and the sixth switching element TA6.

In the light emission period PA7, the light emitting element EEA may emit light based on the driving current. The driving current of the light emitting element EEA may be proportional to a square of a difference between the pixel reference voltage VR and the data voltage VDATA.

In the light emission period PA7, the gate voltage (the voltage of the first node NA1) of the first switching element TA1 may be ELVDD-VTH+ (VDATA-VR) and the source voltage of the first switching element TA1 may be ELVDD so that the driving current may be represented by Equation 2.

$$I = \frac{1}{2} μ {C}_{o x} \frac{W}{L} {( V R - V D A T A )}^{2} \qquad [ Equation 2 ]$$

Herein, I represents the driving current, μ represents a mobility of the first switching element TA1, Cox represents a capacitance per a unit area of the first switching element TA1 and W/L may represent a ratio of a width and a length of a channel of the first switching element TA1.

Equation 2 does not include a factor representing the threshold voltage of the first switching element TA1. Accordingly, it can be understood that the threshold voltage of the first switching element TA1 is compensated. Alternatively, it may be understood that the driving current is not based on the threshold voltage of the first switching element TA1.

According to some example embodiments, the gamma voltage control circuit 700 may generate the first reference voltage VAREG and the second reference voltage VAREF using the pixel reference voltage VR fed back (or received from) from the display panel 100.

Thus, the change of the pixel reference voltage VR may be reflected in the first reference voltage VAREG and the second reference voltage VAREF, the change of the pixel reference voltage VR may be reflected in the gamma voltage VGREF generated by the first reference voltage VAREG and the second reference voltage VAREF and the change of the pixel reference voltage VR may be reflected in the data voltage VDATA generated by the gamma voltage VGREF.

The change of the pixel reference voltage VR is reflected in the data voltage VDATA so that the crosstalk of the display panel 100 may be reduced or limited in a pixel structure in which the luminance of the light emitting element EE of the pixel P is determined based on the driving current proportional to the square of the difference between the data voltage VDATA and the pixel reference voltage VR.

In addition, when the level of the pixel reference voltage VR is changed according to a change of a driving condition such as a luminance, a frequency, a temperature, an image pattern and the like, the change of the pixel reference voltage VR may be reflected in the data voltage VDATA so that optical characteristics of the display panel 100 such as a luminance uniformity, a color uniformity, a flicker may be improved or increased.

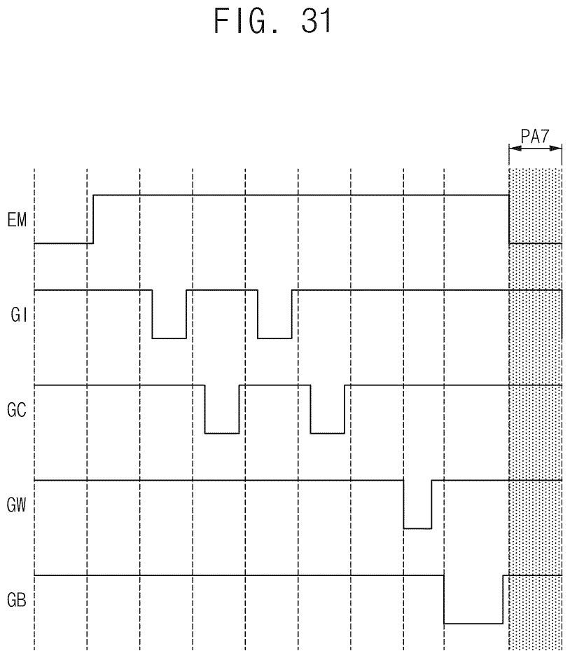

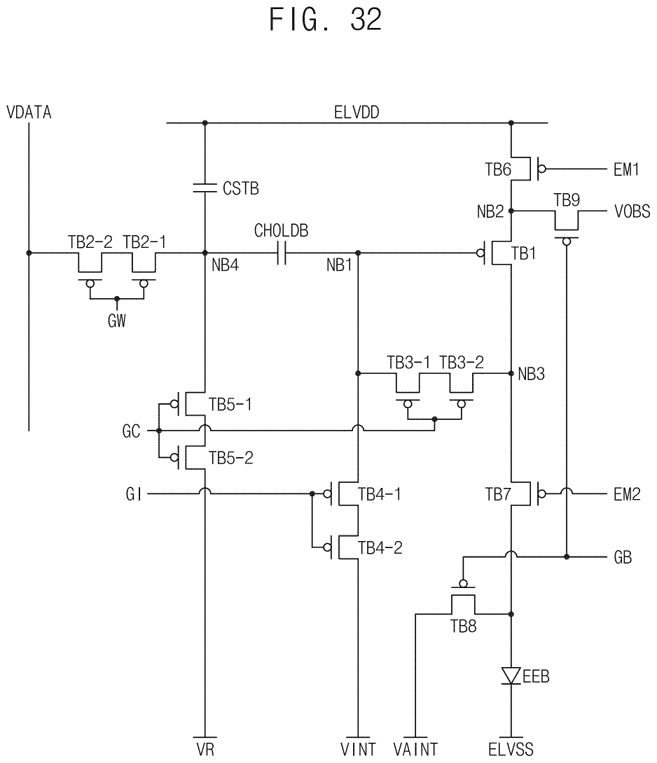

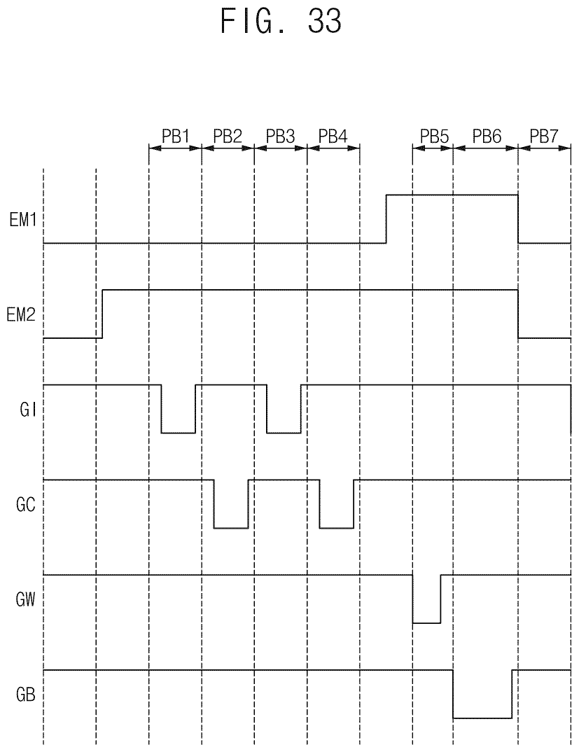

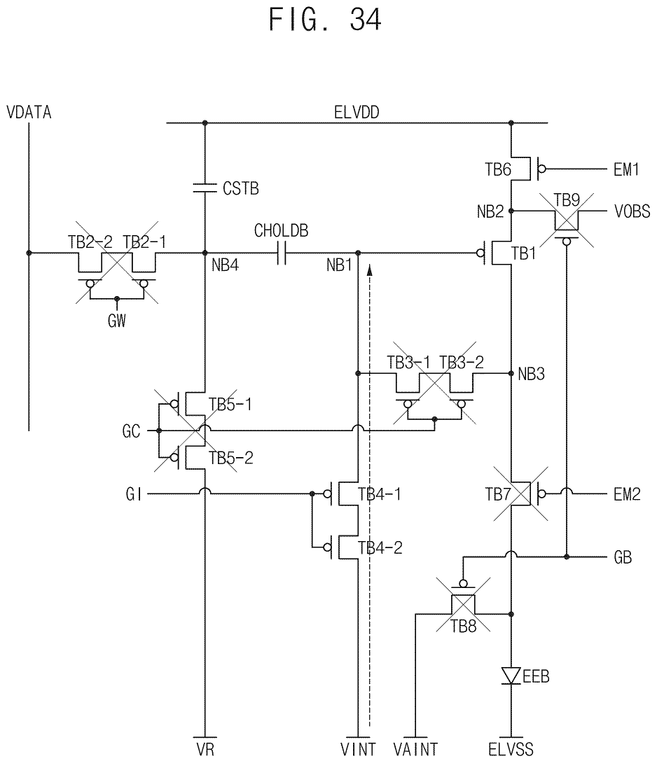

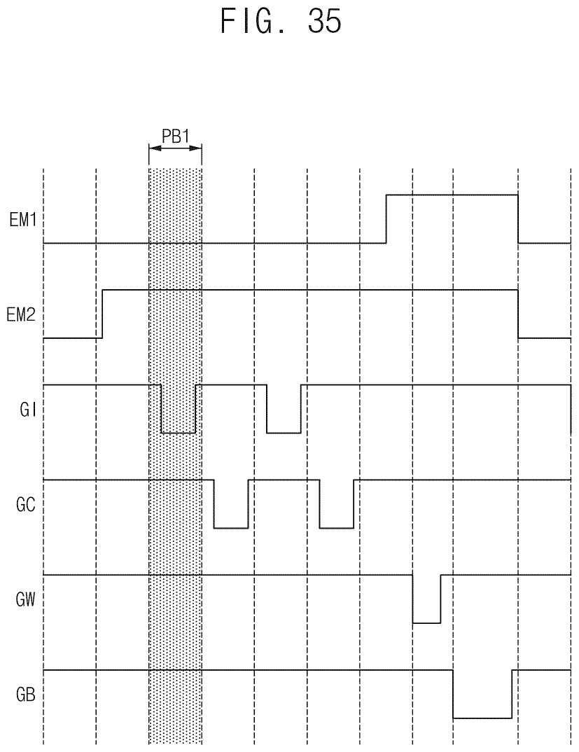

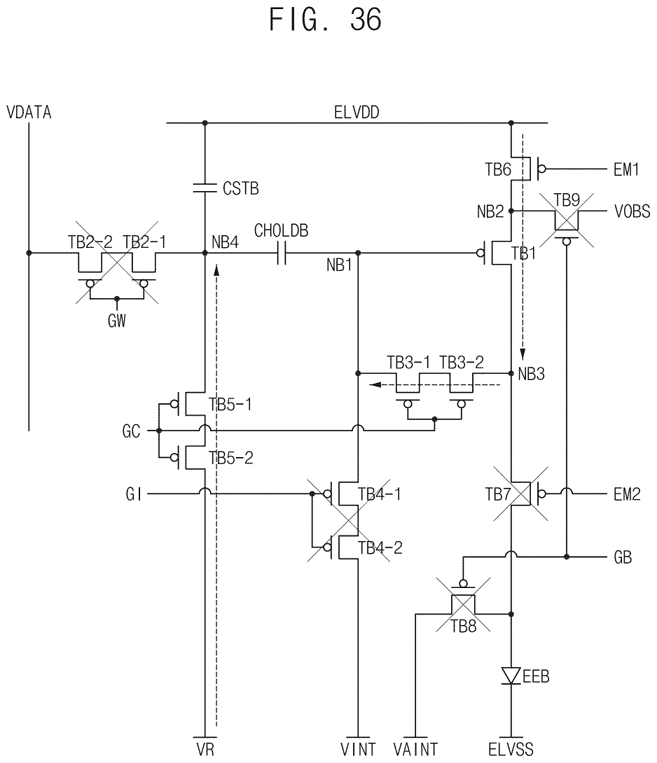

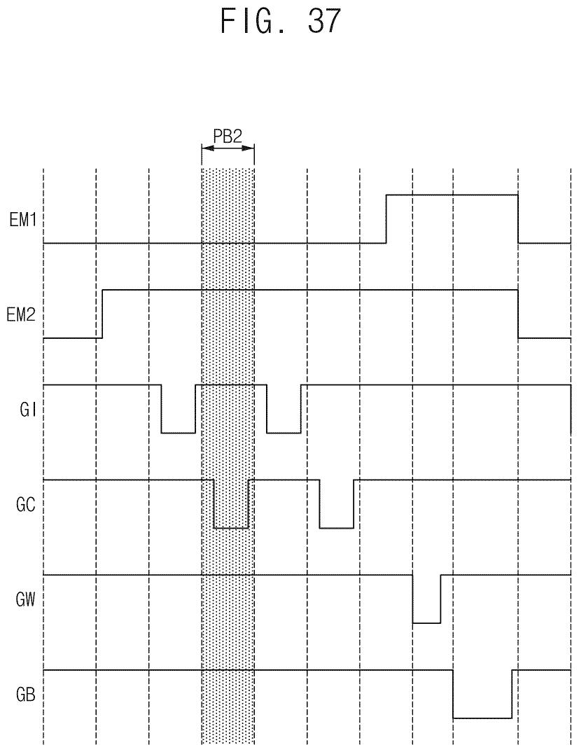

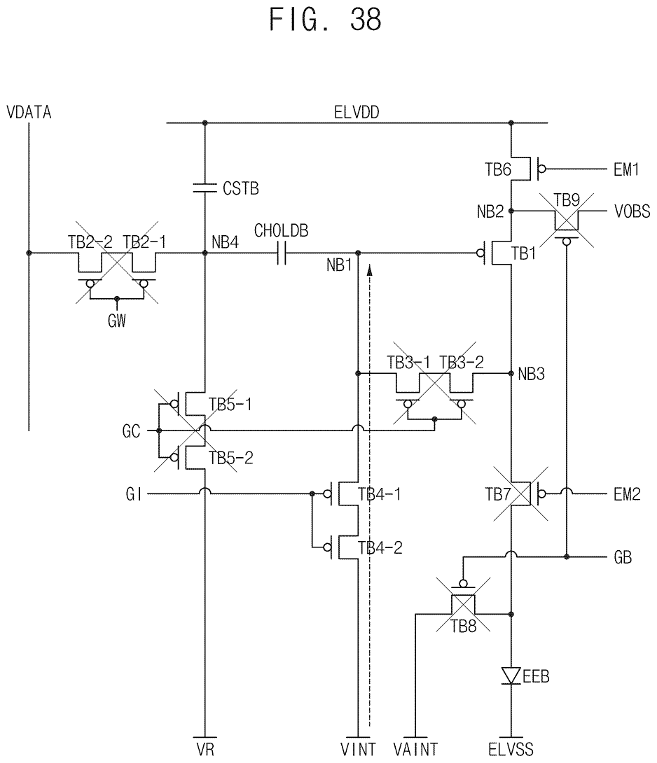

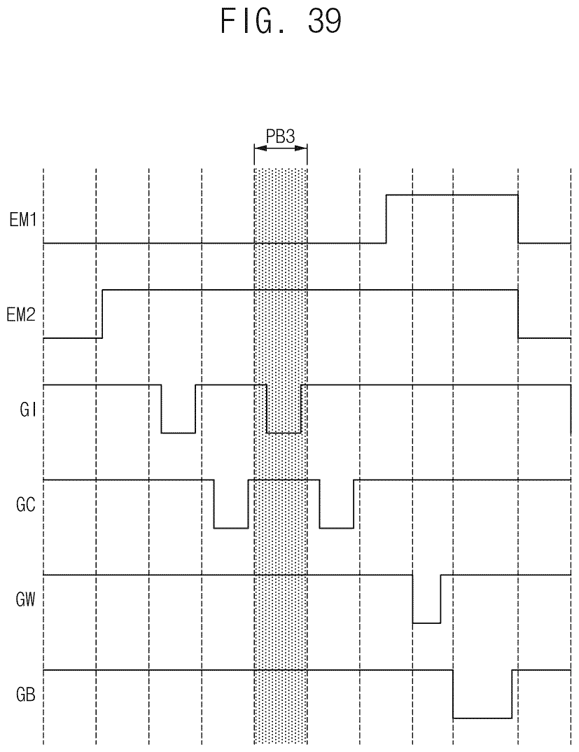

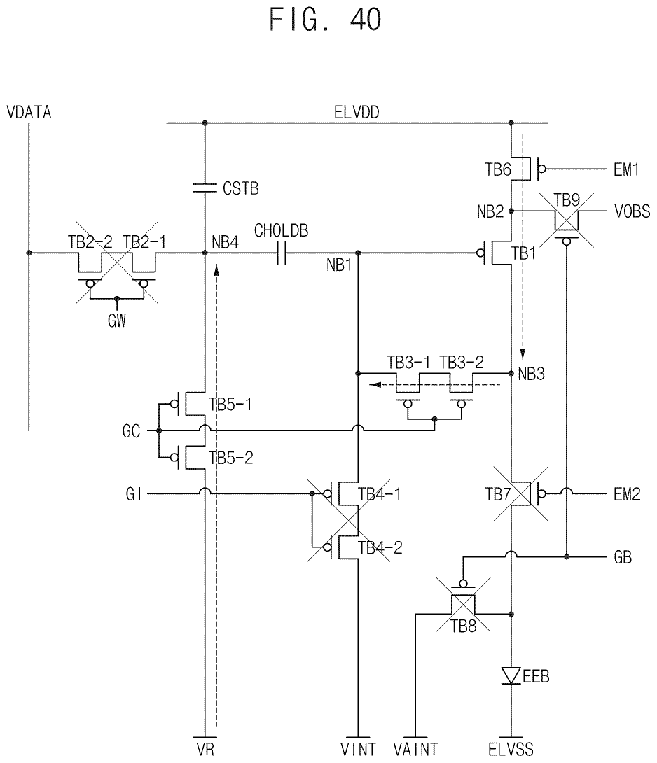

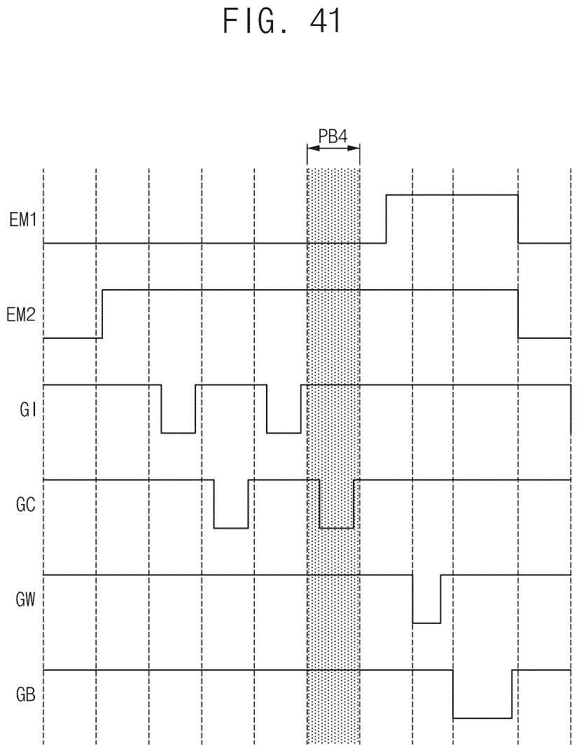

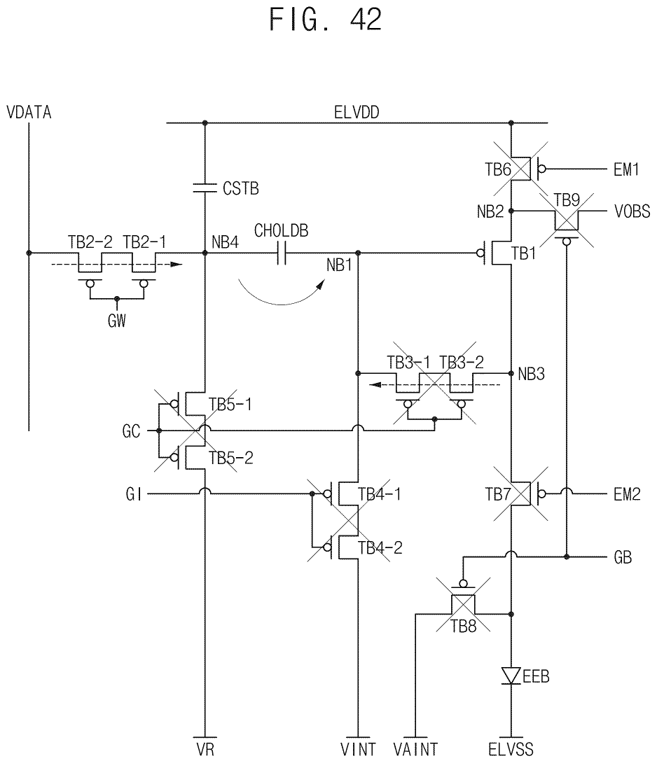

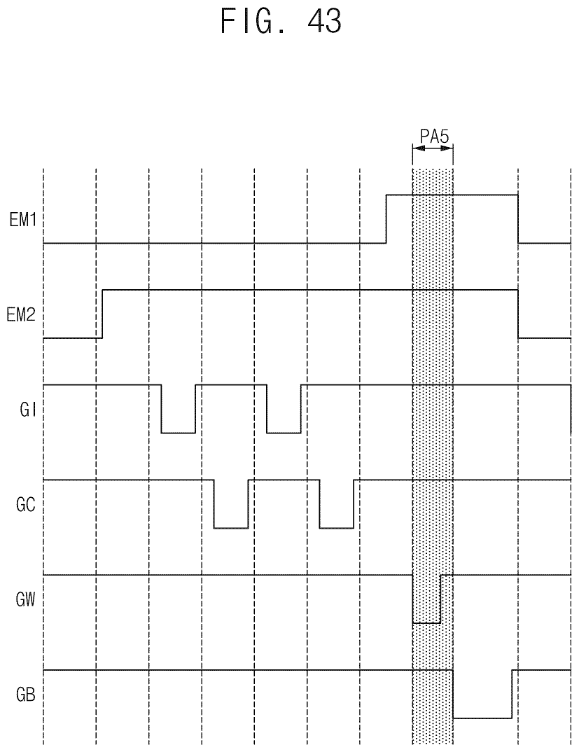

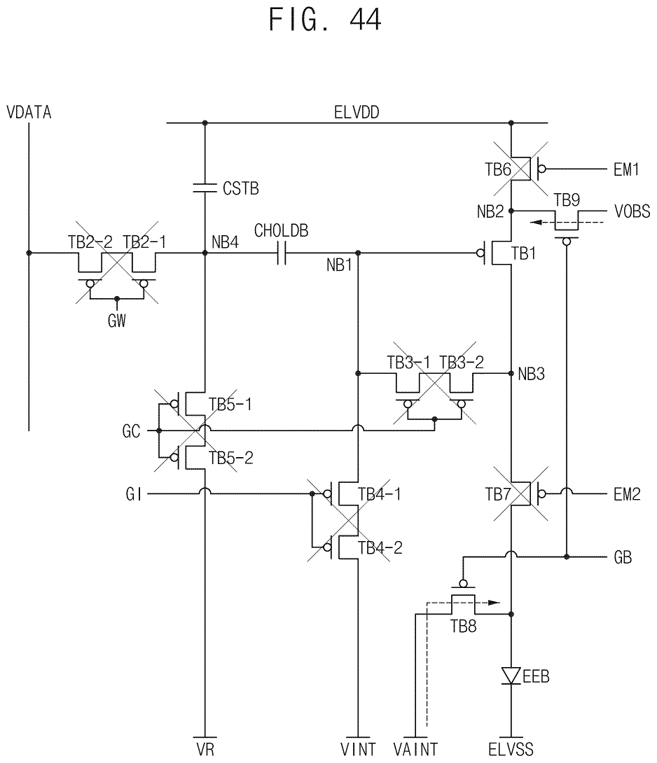

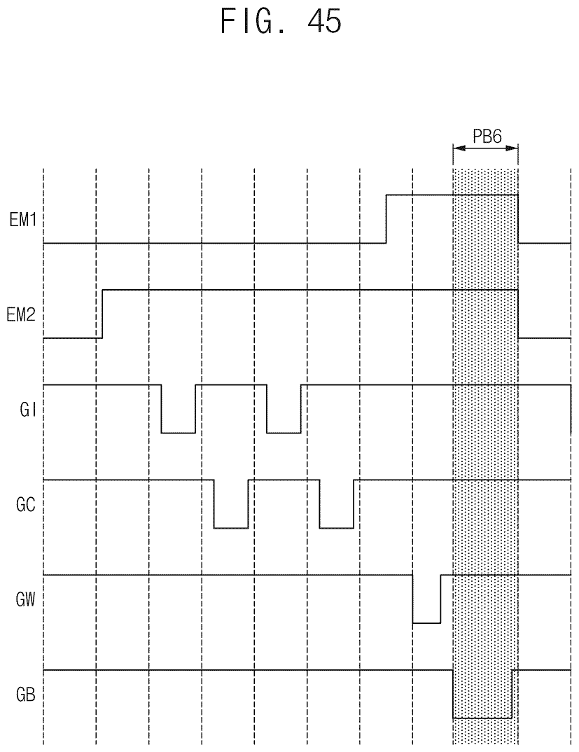

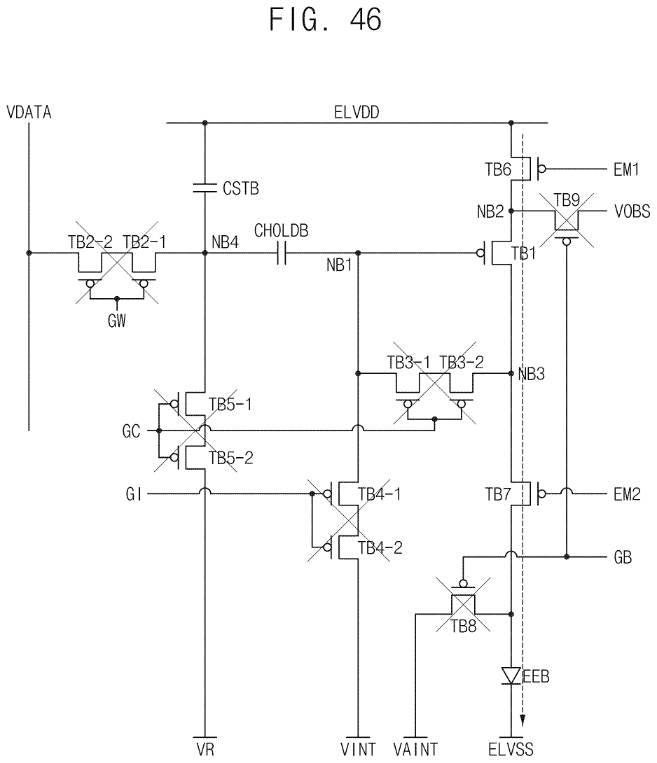

FIG. 32 is a circuit diagram illustrating a pixel P of a display panel 100 of a display apparatus according to some example embodiments of the present inventive concepts. FIG. 33 is a timing diagram illustrating input signals applied to the pixel P of FIG. 32. FIG. 34 is a circuit diagram illustrating an operation of the pixel P of FIG. 32 in a first period PB1 of FIG. 33. FIG. 35 is a circuit diagram illustrating the input signals applied to the pixel P of FIG. 32 in the first period PB1 of FIG. 33. FIG. 36 is a circuit diagram illustrating an operation of the pixel P of FIG. 32 in a second period PB2 of FIG. 33. FIG. 37 is a circuit diagram illustrating the input signals applied to the pixel P of FIG. 32 in the second period PB2 of FIG. 33. FIG. 38 is a circuit diagram illustrating an operation of the pixel P of FIG. 32 in a third period PB3 of FIG. 33. FIG. 39 is a circuit diagram illustrating the input signals applied to the pixel P of FIG. 32 in the third period PB3 of FIG. 33. FIG. 40 is a circuit diagram illustrating an operation of the pixel P of FIG. 32 in a fourth period PB4 of FIG. 33. FIG. 41 is a circuit diagram illustrating the input signals applied to the pixel P of FIG. 32 in the fourth period PB4 of FIG. 33. FIG. 42 is a circuit diagram illustrating an operation of the pixel P of FIG. 32 in a fifth period PB5 of FIG. 33. FIG. 43 is a circuit diagram illustrating the input signals applied to the pixel P of FIG. 32 in the fifth period PB5 of FIG. 33. FIG. 44 is a circuit diagram illustrating an operation of the pixel P of FIG. 32 in a sixth period PB6 of FIG. 33. FIG. 45 is a circuit diagram illustrating the input signals applied to the pixel P of FIG. 32 in the sixth period PB6 of FIG. 33. FIG. 46 is a circuit diagram illustrating an operation of the pixel P of FIG. 32 in a seventh period PB7 of FIG. 33. FIG. 47 is a circuit diagram illustrating the input signals applied to the pixel P of FIG. 32 in the seventh period PB7 of FIG. 33.

The display apparatus referenced in FIGS. 32 to 47, according to some example embodiments, may be same as or similar in some respects to the display apparatus of FIGS. 1 to 14, and therefore may be best understood with reference thereto where like numerals indicate like elements not described again in detail.

Referring to FIGS. 1, 2A, 2B, 13, 14 and 32 to 47, the display apparatus includes a display panel 100 and a display panel driver. The display panel driver includes a driving controller 200, a gate driver 300, a gamma voltage generating circuit 400 and a data driver 500.

The display panel driver may further include a reference voltage generator 600 generating a pixel reference voltage VR applied to the display panel 100. The display panel driver may further include a gamma voltage control circuit 700 outputting a first reference voltage VAREG and a second reference voltage VAREF to the gamma voltage generating circuit 400.

The gamma voltage control circuit 700 may generate the first reference voltage VAREG and the second reference voltage VAREF in which a change of the pixel reference voltage VR is reflected. The gamma voltage control circuit 700 may output the first reference voltage VAREG and the second reference voltage VAREF to the gamma voltage generating circuit 400.

The pixel P may operate in response to an initialization gate signal GI, a compensation gate signal GC, a writing gate signal GW, a light emitting element initialization gate signal GB, a first emission signal EM1 and a second emission signal EM2. Herein, the compensation gate signal GC may be referred to as a reference gate signal. In some example embodiments, the initialization gate signal GI, the compensation gate signal GC, the writing gate signal GW, the light emitting element initialization gate signal GB, the first emission signal EM1, and the second emission signal EM2 may be generated by the gate driver 300 in response to the first control signal CONT1. In some example embodiments, the data driver 500 may generate a data voltage VDATA, a light emitting element initialization voltage VAINT, an initialization voltage VINT, a bias voltage VOBS, a first power voltage ELVDD, and a second power voltage ELVSS based on the first reference voltage is VAREG, the second reference voltage is VAREF, and/or the gamma voltage VGREF, and based on the second control signal CONT2 and/or a data signal DATA.

A light emitting element EEB of the pixel P emits a light based on the data voltage VDATA and the pixel reference voltage VR. A driving current of the light emitting element EEB of the pixel P may be proportional to a square of a difference between the data voltage VDATA and the pixel reference voltage VR.

The pixel P may include the light emitting element EEB, a first switching element TB1 including a control electrode connected to a first node NB1, a first electrode connected to a second node NB2 and a second electrode connected to a third node NB3, a second switching element TB2-1 and TB2-2 including a control electrode receiving the writing gate signal GW, a first electrode receiving the data voltage VDATA and a second electrode connected to a fourth node NB4, a third switching element TB3-1 and TB3-2 including a control electrode receiving the compensation gate signal GC, a first electrode connected to the first node NB1 and a second electrode connected to the third node NB3, a fourth switching element TB4-1 and TB4-2 including a control electrode receiving the initialization gate signal GI, a first electrode receiving an initialization voltage VINT and a second electrode connected to the first node NB1, a fifth switching element TB5-1 and TB5-2 including a control electrode receiving the compensation gate signal GC, a first electrode receiving the pixel reference voltage VR and a second electrode connected to the fourth node NB4, a sixth switching element TB6 including a control electrode receiving the first emission signal EM1, a first electrode receiving a first power voltage ELVDD and a second electrode connected to the second node NB2, a seventh switching element TB7 including a control electrode receiving the second emission signal EM2, a first electrode connected to the third node NB3 and a second electrode connected to an anode electrode of the light emitting element EEB, an eighth switching element TB8 including a control electrode receiving the light emitting element initialization gate signal GB, a first electrode receiving a light emitting element initialization voltage VAINT and a second electrode connected to the anode electrode of the light emitting element EEB and a ninth switching element TB9 including a control electrode receiving the light emitting element initialization gate signal GB, a first electrode receiving a bias voltage VOBS and a second electrode connected to the second node NB2.

As shown in FIG. 32, the second switching element TB2-1 and TB2-2 may have a dual transistor structure including two transistors connected to each other in series. The third switching element TB3-1 and TB3-2 may have a dual transistor structure including two transistors connected to each other in series. The fourth switching element TB4-1 and TB4-2 may have a dual transistor structure including two transistors connected to each other in series. The fifth switching element TB5-1 and TB5-2 may have a dual transistor structure including two transistors connected to each other in series.

Herein, the first switching element TB1 may be referred to as a driving switching element, the second switching element TB2-1 and TB2-2 may be referred to as a data writing switching element, the fifth switching element TB5-1 and TB5-2 may be referred to as a reference switching element and the fourth node NB4 may be referred to as a data writing node.

The pixel P may further include a hold capacitor CHOLDB including a first electrode connected to the first node NB1 and a second electrode connected to the fourth node NB4.

The pixel P may further include a storage capacitor CSTB including a first electrode receiving the first power voltage ELVDD and a second electrode connected to the fourth node NB4.

The light emitting element EEB may include a cathode electrode receiving a second power voltage ELVSS.

For example, the first power voltage ELVDD may be a high power voltage for a light emission of the light emitting element EEB and the second power voltage ELVSS may be a low power voltage for the light emission of the light emitting element EEB. The first power voltage ELVDD may be greater than the second power voltage ELVSS.

For example, the first switching element TB1, the second switching element TB2-1 and TB2-2, the third switching element TB3-1 and TB3-2, the fourth switching element TB4-1 and TB4-2, the fifth switching element TB5-1 and TB5-2, the sixth switching element TB6, the seventh switching element TB7, the eighth switching element TB8 and the ninth switching element TB9 may be P-type transistors.

For example, the first switching element TB1, the second switching element TB2-1 and TB2-2, the third switching element TB3-1 and TB3-2, the fourth switching element TB4-1 and TB4-2, the fifth switching element TB5-1 and TB5-2, the sixth switching element TB6, the seventh switching element TB7, the eighth switching element TB8 and the ninth switching element TB9 may be low temperature polysilicon (LTPS) thin film transistors.

A driving timing of the pixel P may include a first period PB1, a second period PB2, a third period PB3, a fourth period PB4, a fifth period PB5, a sixth period PB6 and a seventh period PB7. The first period PB1 may be an initialization period. The second period PB2 may be a threshold voltage compensation period. The third period PB3 may be a second initialization period. The fourth period PB4 may be a second threshold voltage compensation period. The fifth period PB5 may be a writing period. The sixth period PB6 may be a light emitting element initialization period. The seventh period PB7 may be a light emission period.

As shown in FIGS. 34 and 35, in the initialization period PB1, the first emission signal EM1 may have an active level, the second emission signal EM2 may have an inactive level, the initialization gate signal GI may have an active level, the compensation gate signal GC may have an inactive level, and the writing gate signal GW may have an inactive level. In the initialization period PB1, the light emitting element initialization gate signal GB may have an inactive level. Alternatively, in the initialization period PB1, the light emitting element initialization gate signal GB may have an active level.

In some example embodiments, the switching elements receiving the above signals are all P-type transistors so that active levels may be low levels and inactive levels may be high levels.

In the initialization period PB1, the fourth switching element TB4-1 and TB4-2 may be turned on in response to the initialization gate signal GI so that the initialization voltage VINT may be applied to the first node NB1.

In the initialization period PB1, a voltage of the fourth node NB4 may be a previous data signal (for example, a data signal from a previous operation of the pixel P).

In the initialization period PB1, the sixth switching element TB6 may be turned on in response to the first emission signal EM1 so that the first power voltage ELVDD may be applied to the second node NB2.

As shown in FIGS. 36 and 37, in the compensation period PB2 subsequent to the initialization period PB1, the first emission signal EM1 may have the active level, the second emission signal EM2 may have the inactive level, the initialization gate signal GI may have an inactive level, the compensation gate signal GC may have an active level and the writing gate signal GW may have the inactive level. In the compensation period PB2, the light emitting element initialization gate signal GB may have the inactive level. Alternatively, in the compensation period PB2, the light emitting element initialization gate signal GB may have the active level.

In the compensation period PB2, the fifth switching element TB5-1 and TB5-2 may be turned on in response to the compensation gate signal GC so that the pixel reference voltage VR may be applied to the fourth node NB4.

In the compensation period PB2, the third switching element TB3-1 and TB3-2 may be turned on in response to the compensation gate signal GC, the sixth switching element TB6 may be turned on (or may be remain on) in response to the first emission signal EM1, the first switching element TB1 may be turned on in response to a voltage of the first node NB1 so that a voltage obtained by subtracting a threshold voltage of the first switching element TB1 from the first power voltage ELVDD may be applied to the third node NB3 and the first node NB1.

For example, in the compensation period PB2, a gate voltage of the first switching element TB1 may be a difference ELVDD-VTH between the first power voltage and the threshold voltage of the first switching element TB1, a source voltage of the first switching element TB1 may be the first power voltage ELVDD so that the threshold voltage of the first switching element TB1 may be compensated.

However, in the compensation period PB2, the gate voltage of the first switching element TB1 may be based on previous data.

As shown in FIGS. 38 and 39, in the second initialization period PB3, the first emission signal EM1 may have the active level, the second emission signal EM2 may have the inactive level, the initialization gate signal GI may have the active level, the compensation gate signal GC may have the inactive level and the writing gate signal GW may have the inactive level. In the second initialization period PB3, the light emitting element initialization gate signal GB may have the inactive level. Alternatively, in the second initialization period PB3, the light emitting element initialization gate signal GB may have the active level.

In the second initialization period PB3, the fourth switching element TB4-1 and TB4-2 may be turned on in response to the initialization gate signal GI so that the initialization voltage VINT may be applied to the first node NB1.

In the second initialization period PB3, the voltage of the fourth node NB4 may be the pixel reference voltage VR.

In the second initialization period PB3, the sixth switching element TB6 may be turned on (or may be remain on) in response to the first emission signal EM1 so that the first power voltage ELVDD may be applied to the second node NB2.

As shown in FIGS. 40 and 41, in the second compensation period PB4 subsequent to the second initialization period PB3, the first emission signal EM1 may have the active level, the second emission signal EM2 may have the inactive level, the initialization gate signal GI may have the inactive level, the compensation gate signal GC may have the active level and the writing gate signal GW may have the inactive level. In the second compensation period PB4, the light emitting element initialization gate signal GB may have the inactive level. Alternatively, in the second compensation period PB4, the light emitting element initialization gate signal GB may have the active level.

In the second compensation period PB4, the fifth switching element TB5-1 and TB5-2 may be turned on in response to the compensation gate signal GC so that the pixel reference voltage VR may be applied to the fourth node NB4.

In the second compensation period PB4, the third switching element TB3-1 and

TB3-2 may be turned on in response to the compensation gate signal GC, the sixth switching element TB6 may be turned on (or may be remain on) in response to the first emission signal EM1 and the first switching element TB1 may be turned on (or may be remain on) in response to a voltage of the first node NB1 so that the voltage obtained by subtracting the threshold voltage of the first switching element TB1 from the first power voltage ELVDD may be applied to the third node NB3 and the first node NB1.

For example, in the second compensation period PB4, the gate voltage of the first switching element TB1 may be the difference ELVDD-VTH between the first power voltage and the threshold voltage of the first switching element TB1, the source voltage of the first switching element TB1 may be the first power voltage ELVDD so that the threshold voltage of the first switching element TB1 may be compensated.

In the second compensation period PB4, the gate voltage of the first switching element TB1 may not be based on the previous data and the threshold voltage of the first switching element TB1 may be compensated with relatively improved reliability.

As shown in FIGS. 42 and 43, in the writing period PB5 subsequent to the second compensation period PB4, the first emission signal EM1 may have an inactive level, the second emission signal EM2 may have the inactive level, the initialization gate signal GI may have the inactive level, the compensation gate signal GC may have the inactive level and the writing gate signal GW may have the active level. In the writing period PB5, the light emitting element initialization gate signal GB may have the inactive level. Alternatively, in the writing period PB5, the light emitting element initialization gate signal GB may have the active level.

In the writing period PB5, the second switching element TB2-1 and TB2-2 may be turned on in response to the writing gate signal GW so that the data voltage VDATA may be applied to the fourth node NB4 and the data voltage VDATA applied to the fourth node NB4 may be transmitted to the first node NB1 by a coupling of the hold capacitor CHOLDB.

For example, a voltage change (e.g., VDATA-VR) of the fourth node NB4 may be transmitted to the first node NB1 by the coupling of the hold capacitor CHOLDB. In the writing period PB5, the voltage of the fourth node NB4 may be VDATA, the gate voltage (the voltage of the first node NB1) of the first switching element TB1 may be ELVDD-VTH+ (VDATA-VR) and the source voltage (the voltage of the second node NB2) of the first switching element TB1 may be ELVDD.

As shown in FIGS. 44 and 45, in the light emitting element initialization period PB6 subsequent to the writing period PB5, the first emission signal EM1 may have the inactive level, the second emission signal EM2 may have the inactive level, the initialization gate signal GI may have the inactive level, the compensation gate signal GC may have the inactive level and the writing gate signal GW may have the inactive level. In the light emitting element initialization period PB6, the light emitting element initialization gate signal GB may have an active level.

In the light emitting element initialization period PB6, the eighth switching element TB8 may be turned on in response to the light emitting element initialization gate signal GB so that the light emitting element initialization voltage VAINT may be applied to the anode electrode of the light emitting element EEB.

In the light emitting element initialization period PB6, the ninth switching element TB9 may be turned on in response to the light emitting element initialization gate signal GB so that the bias voltage VOBS may be applied to the second node NB2. In the light emitting element initialization period PB6, the gate voltage (the voltage of the first node NB1) of the first switching element TB1 may be ELVDD-VTH+ (VDATA-VR) and the source voltage (the voltage of the second node NB2) of the first switching element TB1 may be VOBS.

As shown in FIGS. 46 and 47, in the light emission period PB7 subsequent to the light emitting element initialization period PB6, the first emission signal EM1 may have an active level, the second emission signal EM2 may have an active level, the initialization gate signal GI may have the inactive level, the compensation gate signal GC may have the inactive level and the writing gate signal GW may have the inactive level. In the light emission period PB7, the light emitting element initialization gate signal GB may have the inactive level.

In the light emission period PB7, the sixth switching element TB6 may be turned on in response to the first emission signal EM1, the seventh switching element TB7 may be turned on in response to the second emission signal EM2 and the first switching element TB1 may be turned on (or may remain on) in response to the voltage of the first node NB1 so that the driving current may flow along a path including the sixth switching element TB6, the first switching element TB1 and the sixth switching element TB7.

In the light emission period PB7, the light emitting element EEB may emit light based on the driving current. The driving current of the light emitting element EEB may be proportional to a square of a difference between the pixel reference voltage VR and the data voltage VDATA.

In the light emission period PB7, the gate voltage (the voltage of the first node NB1) of the first switching element TB1 may be ELVDD-VTH+ (VDATA-VR) and the source voltage of the first switching element TB1 may be ELVDD so that the driving current may be represented by Equation 3.

$$I = \frac{1}{2} μ {C}_{o x} \frac{W}{L} {( V R - V D A T A )}^{2} \qquad [ Equation 3 ]$$

Herein, I represents the driving current, μ represents a mobility of the first switching element TB1, Cox represents a capacitance per a unit area of the first switching element TB1 and W/L may represent a ratio of a width and a length of a channel of the first switching element TB1.

Equation 3 does not include a factor representing the threshold voltage of the first switching element TB1. Accordingly, it can be understood that the threshold voltage of the first switching element TB1 is compensated. Alternatively, it may be confirmed that the driving current is not based on the threshold voltage of the first switching element TB1.

According to some example embodiments, the gamma voltage control circuit 700 may generate the first reference voltage VAREG and the second reference voltage VAREF using the pixel reference voltage VR fed back (or received) from the display panel 100.

Thus, the change of the pixel reference voltage VR may be reflected in the first reference voltage VAREG and the second reference voltage VAREF, the change of the pixel reference voltage VR may be reflected in the gamma voltage VGREF generated by the first reference voltage VAREG and the second reference voltage VAREF and the change of the pixel reference voltage VR may be reflected in the data voltage VDATA generated by the gamma voltage VGREF.

The change of the pixel reference voltage VR is reflected in the data voltage VDATA so that the crosstalk of the display panel 100 may be reduced or limited in a pixel structure in which the luminance of the light emitting element EE of the pixel P is determined based on the driving current proportional to the square of the difference between the data voltage VDATA and the pixel reference voltage VR.

In addition, when the level of the pixel reference voltage VR is changed according to a change of a driving condition such as a luminance, a frequency, a temperature, an image pattern and the like, the change of the pixel reference voltage VR may be reflected to the data voltage VDATA so that optical characteristics of the display panel 100 such as a luminance uniformity, a color uniformity, a flicker and the like may be improved or increased.

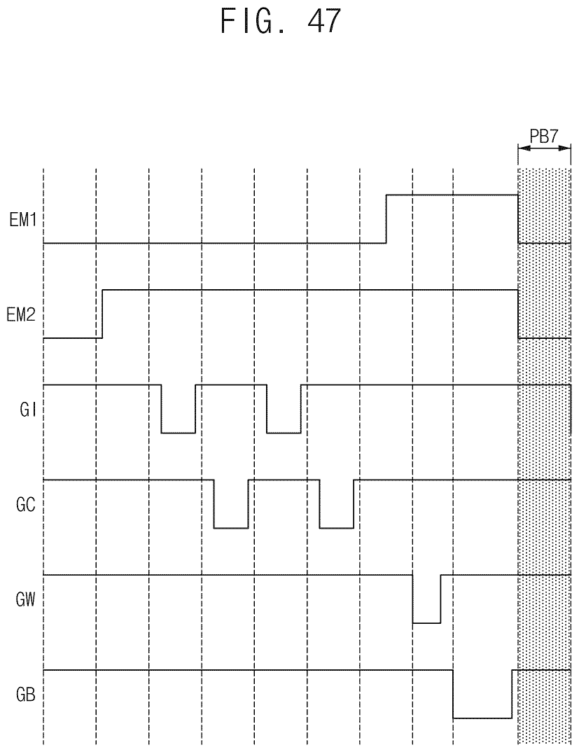

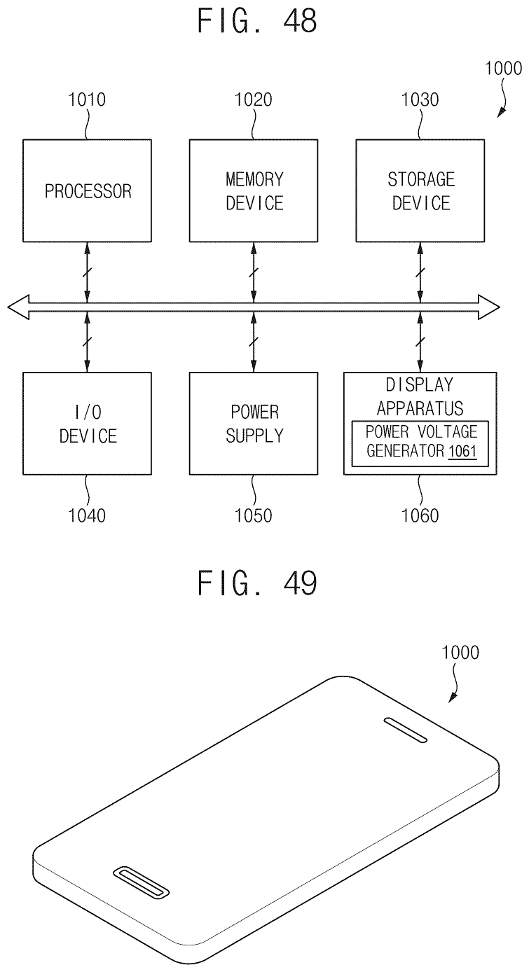

FIG. 48 is a block diagram illustrating an electronic apparatus 1000 according to some example embodiments of the present inventive concepts. FIG. 49 is a diagram illustrating an example in which the electronic apparatus 1000 of FIG. 48 is implemented as a smart phone.

Referring to FIGS. 1 to 49, the electronic apparatus 1000 may include a processor 1010, a memory device 1020, a storage device 1030, an input/output (I/O) device 1040, a power supply 1050 and a display apparatus 1060. In some example embodiments, the display apparatus 1060 may be the display apparatus of FIG. 1. In some example embodiments, the electronic apparatus 1000 may further include a plurality of ports for communicating with a video card, a sound card, a memory card, a universal serial bus (USB) device, other electronic apparatuses, etc.

In some example embodiments, as illustrated in FIG. 49, the electronic apparatus 1000 may be or include a smart phone. However, the electronic apparatus 1000 is not limited thereto. In some example embodiments, the electronic apparatus 1000 may be or include a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some example embodiments, the display apparatus 1060 may be included in the I/O device 1040. The power supply 1050 may provide power for operations of the electronic apparatus 1000. The display apparatus 1060 may be coupled to other components via the buses or other communication links.

The power supply 1050 may include a battery of the electronic apparatus 1000. The power supply 1050 may output the battery voltage to a power voltage generator 1061 of the display apparatus. The power voltage generator 1061 of the display apparatus may generate the analog power voltage VLIN based on the battery voltage. The power voltage generator 1061 may output the analog power voltage VLIN to the gamma voltage control circuit 700. The gamma voltage control circuit 700 may generate the analog reference voltage VCIR based on the analog power voltage VLIN.

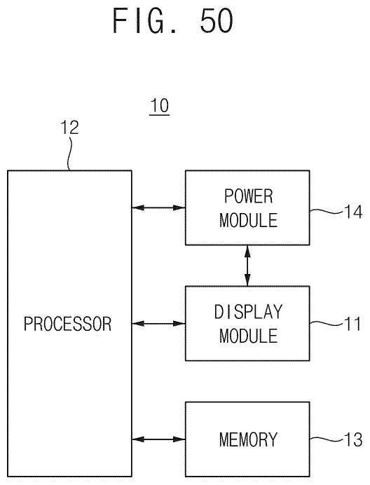

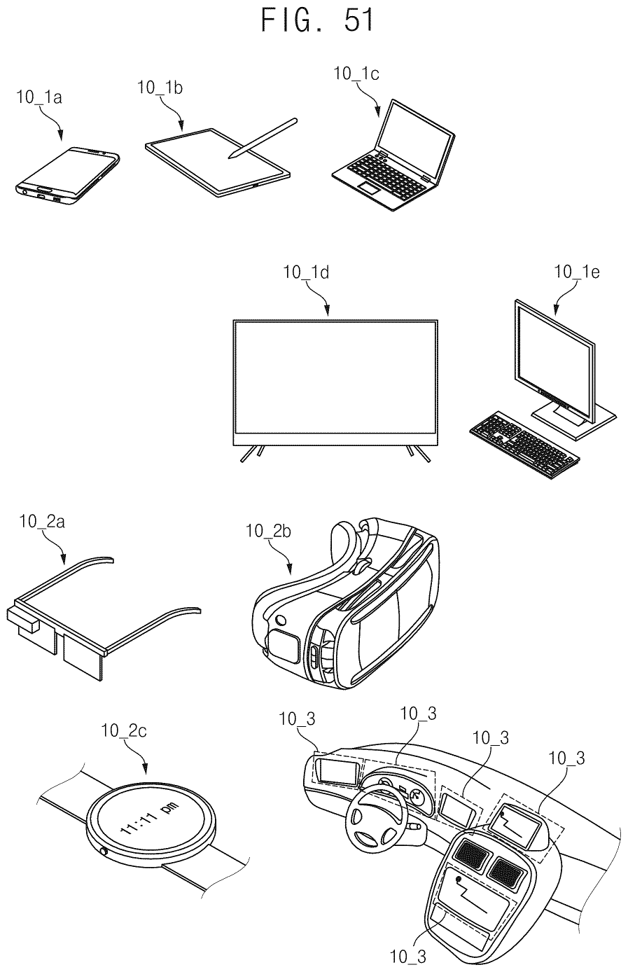

FIG. 50 is a block diagram illustrating an electronic apparatus 10 according to some example embodiments of the present inventive concepts. FIG. 51 illustrates the electronic apparatus of FIG. 50 embodied in different electronic apparatuses.

Referring to FIG. 50, the electronic apparatus 10 according to some example embodiments may include a display module 11, a processor 12, a memory 13 and a power module 14.

The display apparatus according to the some example embodiments of the present inventive concepts may be used in various electronic apparatuses.

In some example embodiments, the electronic apparatus 10 may include the display apparatus of FIG. 1. An operation of the display apparatus included in the electronic apparatus 10 may be the same as or similar in some respects to the operation of the display apparatus discussed with reference to FIGS. 1 to 47. The electronic apparatus 10 may further include a module or an apparatus having additional functions in addition to the display apparatus.

The processor 12 may include at least one of a central processing unit (CPU), an application processor (AP), a graphic processing unit (GPU), a communication processor (CP), an image signal processor (ISP) and a controller.

In some example embodiments, the processor 12 may provide the input control signal CONT of FIG. 1 and the input image data IMG of FIG. 1 to the driving controller 200 included in the display apparatus of FIG. 1.

In some example embodiments, the processor 12 may be divided into two or more operational units from a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display apparatus of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information used for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power used for the operation of the electronic apparatus 10.

At least one of the elements of the electronic apparatus 10 may be included in the display apparatus according to some example embodiments of the present inventive concepts. In some example embodiments, a part of a single functional module may be included in the display apparatus and another part of the single functional module may be disposed out of the display apparatus. For example, the display module 11 may be included in the display apparatus and the processor 12, the memory 13 and the power module 14 may be included in another device or circuit in the electronic apparatus 10 which may be different from the display apparatus.

Referring to FIG. 51, the different electronic apparatuses including the display apparatus according to some example embodiments may include electronic apparatuses for displaying image such as a smartphone 10_1a, a tablet PC 10_1b, a laptop 10_1c, a television 10_1d, a desktop monitor 10_1e, wearable electronic apparatuses including a display module such as smart glasses 10_2a, a head mounted display 10_2b and a smart watch 10_2c and vehicle electronic apparatuses 10_3 including display modules such as a CID (center information display), a room mirror display disposed on an instrument panel, center fascia, and a dashboard of a vehicle. The electronic apparatus 10 may not be limited to the electronic apparatuses for displaying image, the wearable electronic apparatuses, and the vehicle electronic apparatuses 10_3.

According to the display apparatus and the electronic apparatus including the display apparatus of some example embodiments as discussed above, the display quality of the display panel may be improved.

As described herein, any devices, systems, modules, portions, units, controllers, circuits, and/or portions thereof according to any of the example embodiments, and/or any portions thereof (including, without limitation, the driving controller 200, the gate driver 300, the gamma voltage generating circuit 400, the data driver 500, the reference voltage generator 600, the gamma voltage control circuit 700, the processor 1010, the memory device 1020, the storage device 1030, the input/output (I/O) device 1040, the power supply 1050, the processor 12, the memory 13, the power module 14, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

The foregoing is illustrative of the present inventive concepts and is not to be construed as limiting thereof. Although a few example embodiments of the present inventive concepts have been described, those skilled in the art will readily appreciate that many modifications are possible in the example embodiments without materially departing from the novel teachings and advantages of the present inventive concepts. Accordingly, all such modifications are intended to be included within the scope of the present inventive concepts as defined in the claims. In the claims, means-plus-function clauses are intended to cover the structures described herein as performing the recited function and not only structural equivalents but also equivalent structures. Therefore, it is to be understood that the foregoing is illustrative of the present inventive concepts and is not to be construed as limited to the specific example embodiments disclosed, and that modifications to the disclosed example embodiments, as well as other example embodiments, are intended to be included within the scope of the appended claims. The present inventive concepts are defined by the following claims, with equivalents of the claims to be included therein.

What is claimed is:

1. A display apparatus comprising:
a display panel including at least one pixel;
a reference voltage generator configured to output a pixel reference voltage to the display panel;
a gate driver configured to output a gate signal to the display panel;
a data driver configured to output a data voltage to the display panel;
a gamma voltage generating circuit configured to output a gamma voltage to the data driver; and
a gamma voltage control circuit configured to output a first reference voltage and a second reference voltage to the gamma voltage generating circuit,
wherein the gamma voltage control circuit comprises,
a first amplifier configured to generate the first reference voltage based on a first primitive reference voltage, the pixel reference voltage received from the display panel, and an internal reference voltage; and
a second amplifier configured to generate the second reference voltage based on a second primitive reference voltage, the pixel reference voltage, and the internal reference voltage.

2. The display apparatus of claim 1, wherein the first amplifier comprises:
a non-inverting input terminal configured to receive the first primitive reference voltage and the pixel reference voltage;
an inverting input terminal configured to receive the internal reference voltage; and
an output terminal configured to output the first reference voltage.

3. The display apparatus of claim 2, wherein the first amplifier further comprises:
a first resistor including a first end configured to receive the first primitive reference voltage and a second end connected to the non-inverting input terminal of the first amplifier;
a second resistor including a first end configured to receive the pixel reference voltage and a second end connected to the non-inverting input terminal of the first amplifier;
a third resistor including a first end configured to receive the internal reference voltage and a second end connected to the inverting input terminal of the first amplifier; and
a fourth resistor including a first end connected to the inverting input terminal of the first amplifier and a second end connected to the output terminal of the first amplifier.

4. The display apparatus of claim 2, wherein the gamma voltage control circuit is configured to generate the first reference voltage such that a relationship VAREG=VREG+VR-VNR is satisfied,
wherein VAREG represents the first reference voltage, VREG represents the first primitive reference voltage, VR represents the pixel reference voltage, and VNR represents the internal reference voltage.

5. The display apparatus of claim 1, wherein the second amplifier comprises:
a non-inverting input terminal configured to receive the second primitive reference voltage and the pixel reference voltage;
an inverting input terminal configured to receive the internal reference voltage; and
an output terminal configured to output the second reference voltage.

6. The display apparatus of claim 5, wherein the gamma voltage control circuit is configured to generate the second reference voltage such that a relationship VAREF=VREF+VR−VNR is satisfied,
wherein VREF represents the second primitive reference voltage, VR represents the pixel reference voltage, and VNR represents the internal reference voltage.

7. The display apparatus of claim 1, wherein the gamma voltage control circuit comprises:
a third amplifier configured to generate the first primitive reference voltage;
a resistor string including a first end configured to receive an analog reference voltage; and
a first decoder connected between the resistor string and the third amplifier.

8. The display apparatus of claim 7, wherein the third amplifier comprises:
a non-inverting input terminal connected to the first decoder;
an inverting input terminal;
an output terminal configured to output the first primitive reference voltage;
a first resistor connected between the output terminal and the inverting input terminal; and
a second resistor connected between the inverting input terminal and a ground.

9. The display apparatus of claim 7, wherein the gamma voltage control circuit further comprises:
a fourth amplifier configured to generate the second primitive reference voltage; and
a second decoder connected between the resistor string and the fourth amplifier, and
wherein the fourth amplifier comprises,
a non-inverting input terminal connected to the second decoder;
an inverting input terminal;
an output terminal configured to output the second primitive reference voltage;
a first resistor connected between the output terminal and the inverting input terminal; and
a second resistor connected between the inverting input terminal and a ground.

10. The display apparatus of claim 7, wherein the gamma voltage control circuit further comprises:
a fourth amplifier configured to generate the internal reference voltage; and
a third decoder connected between the resistor string and the fourth amplifier, and
wherein the fourth amplifier comprises,
a non-inverting input terminal connected to the third decoder;
an inverting input terminal;
an output terminal configured to output the internal reference voltage;
a first resistor connected between the output terminal and the inverting input terminal; and
a second resistor connected between the inverting input terminal and a ground.

11. The display apparatus of claim 1, wherein the at least one pixel includes a light emitting element, and the light emitting element is configured to output a driving current that is proportional to a square of a difference between the data voltage and the pixel reference voltage.

12. The display apparatus of claim 1, wherein the at least one pixel comprises:
a light emitting element;
a first switching element including a control electrode connected to a first node, a first electrode connected to a second node, and a second electrode connected to a third node;
a second switching element including a control electrode configured to receive a writing gate signal, a first electrode configured to receive the data voltage, and a second electrode connected to the first node;
a third switching element including a control electrode configured to receive a reference gate signal, a first electrode configured to receive the pixel reference voltage, and a second electrode connected to the first node;
a fourth switching element including a control electrode configured to receive a light emitting element initialization gate signal, a first electrode configured to receive a light emitting element initialization voltage, and a second electrode connected to an anode electrode of the light emitting element;
a fifth switching element including a control electrode configured to receive a first emission signal, a first electrode configured to receive a first power voltage, and a second electrode connected to the second node; and
a sixth switching element including a control electrode configured to receive a second emission signal, a first electrode connected to the third node, and a second electrode connected to the anode electrode of the light emitting element.

13. The display apparatus of claim 12, wherein
the first emission signal has an inactive level in a first period of a driving timing of the at least one pixel,
the second emission signal has an active level in the first period,
the reference gate signal has an active level in the first period,
the writing gate signal has an inactive level in the first period,
the first emission signal has an active level in a second period subsequent to the first period,
the second emission signal has an inactive level in the second period,
the reference gate signal has the active level in the second period,
the writing gate signal has the inactive level in the second period,
the first emission signal has the inactive level in a third period subsequent to the second period,
the second emission signal has the inactive level in the third period,
the reference gate signal has an inactive level in the third period,
the writing gate signal has an active level in the third period,
the light emitting element initialization gate signal has an active level in the third period,
the first emission signal has the active level in a fourth period subsequent to the third period,
the second emission signal has the active level in the fourth period,
the reference gate signal has the inactive level in the fourth period,
the writing gate signal has the inactive level in the fourth period, and
the light emitting element initialization gate signal has an inactive level in the fourth period.

14. The display apparatus of claim 1, wherein the at least one pixel comprises:
a light emitting element;
a first switching element including a control electrode connected to a first node, a first electrode configured to receive a first power voltage, and a second electrode connected to a second node;
a second switching element including a control electrode configured to receive a writing gate signal, a first electrode configured to receive the data voltage, and a second electrode connected to a third node;
a third switching element including a control electrode configured to receive a compensation gate signal, a first electrode connected to the first node, and a second electrode connected to the second node;
a fourth switching element including a control electrode configured to receive an initialization gate signal, a first electrode configured to receive an initialization voltage, and a second electrode connected to the first node;
a fifth switching element including a control electrode configured to receive the compensation gate signal, a first electrode configured to receive the pixel reference voltage, and a second electrode connected to the third node;
a sixth switching element including a control electrode configured to receive an emission signal, a first electrode connected to the second node, and a second electrode connected to an anode electrode of the light emitting element; and
a seventh switching element including a control electrode configured to receive a light emitting element initialization gate signal, a first electrode configured to receive a light emitting element initialization voltage, and a second electrode connected to the anode electrode of the light emitting element.

15. The display apparatus of claim 1, wherein the at least one pixel comprises:
a light emitting element;
a first switching element including a control electrode connected to a first node, a first electrode connected to a second node, and a second electrode connected to a third node;
a second switching element including a control electrode configured to receive a writing gate signal, a first electrode configured to receive the data voltage, and a second electrode connected to a fourth node;
a third switching element including a control electrode configured to receive a compensation gate signal, a first electrode connected to the first node, and a second electrode connected to the third node;
a fourth switching element including a control electrode configured to receive an initialization gate signal, a first electrode configured to receive an initialization voltage, and a second electrode connected to the first node;
a fifth switching element including a control electrode configured to receive the compensation gate signal, a first electrode configured to receive the pixel reference voltage, and a second electrode connected to the fourth node;
a sixth switching element including a control electrode configured to receive a first emission signal, a first electrode configured to receive a first power voltage, and a second electrode connected to the second node;
a seventh switching element including a control electrode configured to receive a second emission signal, a first electrode connected to the third node, and a second electrode connected to an anode electrode of the light emitting element;
an eighth switching element including a control electrode configured to receive a light emitting element initialization gate signal, a first electrode configured to receive a light emitting element initialization voltage, and a second electrode connected to the anode electrode of the light emitting element; and
a ninth switching element including a control electrode configured to receive the light emitting element initialization gate signal, a first electrode configured to receive a bias voltage, and a second electrode connected to the second node.

16. A display apparatus comprising:
a display panel including at least one pixel;
a reference voltage generator configured to output a pixel reference voltage to the display panel;
a data driver configured to output a data voltage to the display panel;
a gamma voltage generating circuit configured to output a gamma voltage to the data driver; and
a gamma voltage control circuit configured to output a first reference voltage and a second reference voltage to the gamma voltage generating circuit,
wherein the at least one pixel comprises,
a light emitting element;
a driving switching element configured to apply a driving current to the light emitting element;
a data writing switching element configured to apply the data voltage to a data writing node; and
a reference switching element configured to apply the pixel reference voltage to the data writing node, and
wherein the pixel reference voltage is provided from the display panel to the gamma voltage control circuit.

17. The display apparatus of claim 16, wherein the data writing node is directly connected to a control electrode of the driving switching element.

18. The display apparatus of claim 16, wherein the at least one pixel further comprises a hold capacitor including a first electrode connected to the data writing node and a second electrode connected to a control electrode of the driving switching element.

19. The display apparatus of claim 16, wherein the gamma voltage control circuit comprises:
a first amplifier configured to generate the first reference voltage based on a first primitive reference voltage, the pixel reference voltage, and an internal reference voltage; and
a second amplifier configured to generate the second reference voltage based on a second primitive reference voltage, the pixel reference voltage, and the internal reference voltage.

20. An electronic apparatus comprising:
a display panel including at least one pixel;
a reference voltage generator configured to output a pixel reference voltage to the display panel;
a data driver configured to output a data voltage to the display panel;
a gamma voltage generating circuit configured to output a gamma voltage to the data driver;
a gamma voltage control circuit configured to output a first reference voltage and a second reference voltage to the gamma voltage generating circuit;
a driving controller configured to control the data driver;
a processor configured to output input image data and an input control signal to the driving controller;
a power voltage generator configured to generate an analog power voltage based on a battery voltage and output the analog power voltage to the gamma voltage control circuit; and
a power supply configured to output the battery voltage to the power voltage generator,
wherein the at least one pixel comprises,
a light emitting element;
a driving switching element configured to apply a driving current to the light emitting element;
a data writing switching element configured to apply the data voltage to a data writing node; and
a reference switching element configured to apply the pixel reference voltage to the data writing node,
wherein the gamma voltage control circuit is configured to generate an analog reference voltage based on the analog power voltage and to generate a first primitive reference voltage, a second primitive reference voltage and an internal reference voltage based on the analog reference voltage, and
wherein the gamma voltage control circuit is configured to generate the first reference voltage and the second reference voltage based on the pixel reference voltage provided from the display panel, the first primitive reference voltage, the second primitive reference voltage, and the internal reference voltage.
